(19) United States
(12) Patent Application Publication
(10) Pub. No.: US 2025/0297140 A1
(43) Pub. Date: Sep. 25, 2025

(54) LINERLESS LABEL

(71) Applicant: UPM Raflatac Oy, Tampere (FI)

(72) Inventors: Juha KIVIMÄKI, Helsinki (FI); Katarzyna WOJTUS, Helsinki (FI); Monika BLAZEJEWSKA, Helsinki (FI); Markku HAVONEN, Helsinki (FI); Magdalena RABSKA, Helsinki (FI)

(21) Appl. No.: 18/864,459

(22) PCT Filed: May 10, 2022
(86) PCT No.: PCT/FI2022/050313

§ 371 Date: Nov. 8, 2024

(51) Int. Cl. C09J 7/38; G09F 3/02; G09F 3/10

(52) U.S. Cl. CPC C09J 7/385; G09F 3/02; G09F 3/10; C09J 2203/334; C09J 2433/00; G09F 2003/0211; G09F 2003/023; G09F 2003/026

(57) ABSTRACT

This invention relates to a method for manufacturing a direct thermal linerless label web (100) comprising a face (110) and a water-based acrylic pressure sensitive adhesive coating (120), wherein the face (110) comprises a base layer (113) and a direct thermal printable coating (115), and wherein the method comprises: supplying the face (110), applying a water-based acrylic adhesive coating (121) comprising free and/or non-free surfactant(s), wherein a total amount of the surfactant(s), excluding surface active polymerization agent(s), is from 0 wt. % to less than 0.6 wt. %, calculated from the total dry weight of the water-based acrylic adhesive coating, and thermally drying the water-based acrylic adhesive coating (121) into the water-based acrylic pressure sensitive adhesive coating (120). This invention further relates to a direct thermal linerless label web, and a use of a direct thermal linerless label (100) in on-demand printing.

### TECHNICAL FIELD

This specification relates to a method for manufacturing a direct thermal linerless label web. This specification further relates to a direct thermal linerless label web. This specification further relates to a use of a direct thermal linerless label web in on-demand printing.

### BACKGROUND

Linerless labels having direct thermal face materials may be used for several purposes, such as for on-demand printing. However, conventional linerless labels are known to have caused problems in prolonged use especially in simple and low-cost on-demand printers. These problems may arise from the pressure sensitive adhesive being exposed without protective release liner and thus causing sticky adhesive contamination onto the printer internal mechanisms causing printer jamming and need for additional service.

Further, traditionally, some pressure sensitive adhesives have been difficult to use in linerless labels which comprise direct thermal face materials. Thus, there is still a need for an improved yet simple direct thermal linerless label product, and an improved method for manufacturing direct thermal label products providing consistent and trouble-free performance.

### SUMMARY

It is an aim of this specification to provide a method for manufacturing a direct thermal linerless label web comprising pressure sensitive adhesive. Further, it is an aim of the specification to provide a direct thermal linerless label web comprising pressure sensitive adhesive.

Aspects of the invention are characterized by what is stated in the independent claims. Some preferred embodiments are disclosed in the dependent claims. These and other embodiments are disclosed in the description and figures.

Conventionally, direct thermal linerless label webs may have had a quite limited shelf life creating additional challenges for their logistics and handling or conversion prior to the actual end use as printed labels. Improvements for such problems have mainly been sought by modifications of a thermal layer, or changes in a base layer.

Surprisingly, surfactants added after a polymerization process were found to decrease shelf life of direct thermal linerless labels comprising water-based acrylic pressure sensitive adhesive, as well as cause several challenges relating to said direct thermal linerless labels and their manufacturing methods.

For example, a drying process of a linerless label web comprising a water-based acrylic adhesive was improved while bleeding of the product was decreased merely by using an adhesive formulation comprising minimum amount of free surfactant(s).

The bleeding is a complicated phenomenon which may depend on an effectiveness of an adhesive transferal onto a face, an anchorage level of an adhesive, curing and/or drying stages of a direct thermal linerless label web, and a coat weight of an adhesive layer. However, an adhesive recipe comprising water-based acrylic adhesive having reduced amount of added surfactants was found to be one of key features for minimizing bleeding.

Moreover, surprisingly, a printing quality of aged direct thermal linerless labels was substantially improved by reducing amount of surfactants, such as wetting agents, in the adhesive.

Furthermore, dusting related problems were, surprisingly, reduced by using the water-based acrylic adhesive with minimized wetting agent content. The best results were obtained by using a water-based acrylic adhesive together with a face having reduced mineral content. Thus, while a face and a silicon may typically be main sources of dusting, by minimizing bleeding it was also possible to minimize dusting relating problems of a direct thermal printer. Thanks to the minimized adhesive residual content in a printer, the adhesive residuals may not be able to collect dust and, hence, the formed dust may not be able to stay in the printer.

Therefore, thanks to the novel solution, several problems relating to direct thermal linerless label webs in on-demand printers, such as bleeding, may be avoided or at least substantially diminished. Moreover, shelf life of direct thermal linerless label webs may be improved simplifying their logistics and handling prior to the end use. Still further, printing quality of aged direct thermal linerless labels may be substantially improved.

A direct thermal linerless label web according to this specification may comprise
A) a face having a first side and a second side, the face comprising
   a base layer, and
   a direct thermal printable coating, and
B) a water-based acrylic pressure sensitive adhesive coating on the second side of the face, which water-based acrylic pressure sensitive adhesive coating is obtained from a water-based acrylic adhesive coating comprising free and/or non-free surfactant(s), wherein
a total amount of the surfactant(s), excluding surface active polymerization agent(s), is from 0 wt. % to 0.6 wt. %, calculated from dry weight of the water-based acrylic adhesive coating.

The first side of the face can be the top side of the face, and the second side of the face can be the bottom side of the face.

The surfactant(s) may comprise surface active polymerization agent(s), which is/are used for a polymerization process of the water-based acrylic adhesive coating.

The surface active polymerization agent(s) may comprise one or more than one reactive surface active polymerization agent and/or one or more than one non-reactive surface active polymerization agent.

The reactive surface active polymerization agent(s) can be capable of reacting with acrylic monomers during polymerization process. Thanks to the reactive surface active polymerization agent(s), if used, there may not be free surfactant left in the system after the polymerization process.

Therefore, the water-based acrylic adhesive may comprise non-free surfactant(s). Amount of the non-free surfactant(s), including the surface active polymerization agent(s), may be at least 0.8 wt. %, preferably at least 1 wt. % (by dry weight), determined from dry weight of the water-based acrylic adhesive coating. The non-free surfactant(s), if replacing free surfactant(s), may provide many benefits for the formed water-based acrylic adhesive coating. For example, the non-free surfactant(s) may be substantially uniformly dispersed in the formed PSA layer, hence, improving quality of the direct thermal linerless label web.

One or more than one surfactant can be applied as an additive after the polymerization process to the formed adhesive coating. These surfactants may comprise wetting agent(s), which may be used to increase spreading and penetrating properties by lowering a surface tension. However, the water-based acrylic adhesive according to this specification may not comprise said wetting agents.

In an embodiment, the water-based acrylic adhesive coating comprises free surfactant(s) from 0 wt. % to equal to or less than 2 wt. % (by dry weight). The water-based acrylic adhesive coating preferably comprises free surfactant(s) equal to or less than 1.5 wt. % (by dry weight), more preferably equal to or less than 1.0 wt. % (by dry weight), and most preferably equal to or less than 0.6 wt. % (by dry weight). In this embodiment, said free surfactants include free surface active polymerization agent(s) as well as surfactant(s) added after the polymerization process. In an advantageous embodiment, amount of free surfactants in the water-based acrylic adhesive is less than 0.6 wt. % (by dry weight), more preferably less than 0.5 wt. % (by dry weight), and most preferably equal to or less than 0.3 wt. % (by dry weight).

In an embodiment, a total amount of free surfactant(s), excluding surface active polymerization agent(s), is less than 0.6 wt. %, preferably less than 0.5 wt. %, more preferably in a range between 0 wt. % and 0.3 wt. %, and most preferably in a range between 0 wt. % and 0.2 wt. %, calculated from the dry weight of the water-based acrylic adhesive coating. The technical effect is that the formed water-based acrylic adhesive coating may be dried, substantially easily, into the pressure sensitive adhesive. Further, a printing quality of aged direct thermal linerless labels may be substantially improved. Still further, bleeding of the direct thermal linerless label may be avoided, or at least diminished.

If used, a total amount of wetting agent(s), calculated from the total dry weight of the water-based acrylic adhesive coating, may be less than 0.3 wt. %, preferably in a range between 0 wt. % and 0.2 wt. %. In an embodiment, the water-based acrylic adhesive coating comprises wetting agent(s) equal to or less than 0.2 wt. %, such as in a range between 0.01 wt. % and 0.2 wt. %, calculated from the total dry weight of the water-based acrylic adhesive coating. More preferably, the total amount of wetting agents in the water-based acrylic adhesive coating is equal to or less than 0.1 wt. %, such as in a range between 0.0 wt. % and 0.1 wt. %, calculated from the total dry weight of the water-based acrylic adhesive coating. The technical effect is that a printing quality of aged direct thermal linerless labels may be substantially improved. Further, bleeding of the direct thermal linerless label may be avoided, which may also reduce dusting related problems in a printer.

In an advantageous embodiment, the water-based acrylic adhesive coating comprises equal to or less than 0.6 wt. % (by dry weight) free surfactant(s) and at least 0.8 wt. % (by dry weight) non-free surfactant(s). In this embodiment, thanks to reactive surface active polymerization agent(s) forming non-free surfactants, amount of free surfactants in the water-based acrylic adhesive coating may be reduced. Further, thanks to an increased amount of non-free surfactants and a substantially small amount of free surfactants in the formed water-based acrylic adhesive, the surfactant(s) may be substantially uniformly dispersed in the formed water-based acrylic adhesive. Thus, a quality of the formed linerless label web may be substantially improved.

Thus, in an embodiment, amount of non-free surfactants is greater than amount of free surfactants in the water-based acrylic adhesive coating. To further improve quality of the direct thermal linerless label web comprising water-based acrylic adhesive, in an embodiment, amount of non-free surfactants is at least 10% greater than amount of free surfactants in the water-based acrylic adhesive. More preferably, amount of non-free surfactants is at least 20% greater than amount of free surfactants in the water-based acrylic adhesive. Most preferably, amount of non-free surfactants is at least 30% greater than amount of free surfactants in the water-based acrylic adhesive.

In an embodiment, the adhesive comprises said wetting agent(s), and at least one wetting agent is preferably selected from a group consisting of:
dioctyl sulfosuccinate (DOSS) wetting agent, and
acetylenediol.

In an embodiment, said surfactant(s) added after the polymerization process to the formed water-based acrylic adhesive may further comprise emulsifier(s), for example, an emulsified silicone additive may be added into the water-based acrylic adhesive.

The water-based acrylic adhesive coating can be an aqueous polymer emulsion. Said aqueous polymer emulsion may be derived from components comprising acrylate monomer(s), vinyl aromatic compound(s), and surface active polymerization agent(s). The surface active polymerization agent(s) may consist of non-reactive surface active polymerization agent(s) and/or reactive surface active polymerization agent(s). The surface active polymerization agent(s) may comprise or consist of the reactive surface active polymerization agent(s).

The face may further comprise a top coating on the direct thermal printable coating, wherein the top coating preferably has a grammage in a range between 0.5 g/m² and 3 g/m². The top coating may protect the top surface and/or print of the face against rubbing or other external stress.

The direct thermal linerless label web may further comprise a release layer on top of the face. Non-thermally curable release coatings, such as UV curable silicone, are preferable because curing of such layers may not heat the thermally sensitive material of the direct thermal linerless label web. The release layer may be used for lowering friction against a print head of a printer and minimizing wear of the print head. Furthermore, due to the lowered friction and minimized wear of the print head, a printing quality of the linerless label web may, in some cases, be improved.

The face may further comprise an intermediate layer disposed between the base layer and the direct thermal printable coating. In this embodiment, the intermediate layer may have a grammage in a range between 0.9 g/m² and 7 g/m², preferably in a range between 1 g/m² and 5 g/m². In an embodiment, a total amount of mineral pigments in the intermediate layer may be equal to or less than 4 g/m², preferably equal to or less than 3 g/m², and/or mineral pigment content of the intermediate layer may be less than 85 wt. %, preferably equal to or less than 75 wt. %.

The water-based acrylic pressure sensitive adhesive coating may have a coat weight in a range between 10 g/m² and 25 g/m², calculated as total dry weight of the water-based acrylic pressure sensitive adhesive coating.

In an embodiment, a total coverage of the water-based acrylic pressure sensitive adhesive coating is in a range between 10% and 90%, calculated from total area of the second side.

In an embodiment, the pressure sensitive adhesive coating comprises an emulsified silicone additive, the amount of the emulsified silicone additive being in a range between 1 wt. % and 6 wt. %, preferably in a range between 2 wt. % and 4 wt. %, calculated from the total dry weight of the adhesive coating.

Thus, in an embodiment, the water-based acrylic pressure sensitive adhesive coating may comprise emulsified silicone additive. In this embodiment, an emulsifier may keep the silicone additive as a stable water dispersion. The emulsified silicone additive may comprise a silicone component, for example, a silicone oil (polydimethylsiloxane), at least one emulsifier, and water. The water-based acrylic pressure sensitive adhesive comprising silicone additive, wherein the water-based acrylic pressure sensitive adhesive has reduced wetting agent content, may be easier to cut through mechanically in such devices with less adhesive residue left on the cutting blade or edge.

As discussed, by reducing the bleeding, dusting related problems in a printer may also be reduced. In an embodiment, in order to minimize dusting tendency of the linerless label web, a total mineral content of the direct thermal linerless label web may be in a range between 0 and 20 wt. %, calculated from total dry weight of the direct thermal linerless label web.

Preferably, in order to improve printing quality cost efficiently, the direct thermal printable coating has a grammage in a range between 1 g/m² and 5 g/m².

A method for manufacturing a direct thermal linerless label web may comprise the following steps:
supplying the face,
applying the water-based acrylic adhesive coating, and
thermally drying the adhesive coating into a pressure sensitive adhesive coating,
   thereby obtaining the direct thermal linerless label web.

The water-based acrylic adhesive coating may be applied directly on to the face. Alternatively, the water-based acrylic adhesive coating may be, first, applied on to a carrier material, dried on the carrier material, and then transferred on to the face.

In an embodiment, the direct thermal linerless label web consists of
the face comprising at least
   base layer,
   direct thermal printable coating,
   optionally, a top coating on the direct thermal printable coating, and
   optionally, an intermediate layer disposed between the base layer and the direct thermal printable coating,
optionally, a release coating on the face, and
adhesive coating.

The base layer can be an uncoated base paper or a filmic material. The base layer is preferably a paper for environmental reasons.

As discussed, the water-based acrylic adhesive may comprise free and non-free surfactants. The free surfactants may comprise surfactants added into the adhesive after the polymerization process, such as wetting agents. The free surfactants may, additionally or alternatively, contain, for example, residual surfactants from the polymerization process.

A total amount of at least 0.7 wt. % of wetting agents have considered to be a necessary component for obtaining a good adhesive layer. Surprisingly, by removing wetting agent from adhesive recipes, or at least reducing wetting agent content, it is possible to improve drying process of adhesive coating and, hence, widen the operating window. Further, printing quality can be substantially improved. Moreover, runnability of a printer can be improved.

Surprisingly, printing quality of aged direct thermal linerless label webs was improved by adjusting adhesive recipe. Moreover, surprisingly, a component affecting to printing quality of aged direct thermal linerless label was found to be wetting agent(s). By selecting a wetting agent type and/or a correct dosage of a wetting agent, the inventors were able to significantly increase shelf life of direct thermal linerless labels. Further, a selection of used adhesive had a strong effect on shelf life of direct thermal linerless labels.

Further, thanks to the novel solution, it may be possible to substantially decrease adhesive accumulation on printer rollers and/or a cutting knife. This effect may further be improved by adding a silicone additive into the adhesive composition.

Dusting and bleeding can disturb labelling process and decrease quality of direct thermal printing and eventually might cause a damage to a print head. Thus, by minimizing dusting and bleeding of direct thermal linerless labels, it may be possible to achieve a long, trouble-free printing for the paper-based direct thermal linerless labels. Thanks to the solution according to this specification, dusting and bleeding of direct thermal linerless label webs may be minimized.

Depending on the printer model in question, dust or particle residues or contaminants from the label material can have several different adverse effects in the printer mechanisms. For example, dust may reduce the thermal contact of the print head to the label material and deteriorate the print quality. This may cause hot spots in the printer head and/or be necessary to compensate by using higher print head energies which again shortens the lifetime of the printer. The sticky adhesive residues are often generated especially upon cutting the label material against a manual or motored guillotine mechanism to separate the printed individual label. These residues then may weaken the action of the cutting mechanism itself or become slowly conveyed and accumulated onto the other internals of the printer. Thanks to the novel solution, anchoring of the adhesive to the face may be significantly improved.

Furthermore, surprisingly, the water-based adhesive may be easily dried into the PSA.

Thanks to the novel solution, it is possible to obtain a linerless label web for on-demand linerless label printer in a cost-effective manner, which linerless label may have improved properties for on-demand printers as well as for the labelling purpose.

Further, it may be easier to achieve good, cost efficient, and environmentally friendly product while improving printing quality and decreasing dusting and bleeding tendency of the direct thermal linerless label web.

Furthermore, the method may allow drying of the adhesive e.g., on a face without causing unwanted and premature color changes to the thermally sensitive coating of the direct thermal linerless label web.

### BRIEF DESCRIPTION OF THE DRAWINGS

FIG. 1a illustrates, by way of an example, an Sₓ, S_{y}-cross-section of a linerless label (web),

FIG. 1b illustrates, by way of an example, an Sₓ, S_{y}-cross-section of a face,

FIG. 2 illustrates, by way of an example, a schematic representation of a label printer useable with linerless label web according to the disclosure,

FIG. 3 illustrates, by way of an example, method steps according to an embodiment,

FIG. 4 illustrates, by way of an example, method steps according to an embodiment,

FIG. 5 illustrates, by way of an example, an embodiment of a manufacturing method and an apparatus,

FIG. 6 illustrates, by way of an example, a detail of a manufacturing method and an apparatus according to an embodiment,

FIG. 7 illustrates, by way of an example, a detail of a manufacturing method and an apparatus according to an embodiment,

FIG. 8 illustrates, by way of an example, an embodiment of a manufacturing method and an apparatus, and

FIGS. 9a-b and FIGS. 10a-d show photos from experimental tests.

The figures are schematic and are intended to illustrate the general principles of the disclosed solution. Therefore, the illustrations in the Figures are not necessarily in scale or suggestive of precise layout of system components.

### DETAILED DESCRIPTION

The solution is described in the following in more detail with reference to some embodiments, which shall not be regarded as limiting.

In this specification, references are made to the figures with the following numerals and denotations:

| Sx, Sy, Sz | 3D coordinates, |
|---|---|
| MD | machine direction, first direction, |
| CD | cross direction, second direction, |
| 100 | linerless label web, |
| 110 | face, |
| 111 | first side, i.e., top side, |
| 112 | second side, i.e. bottom side, |
| 113 | base layer, such as a paper, |
| 114 | intermediate layer, |
| 115 | direct thermal printable coating, |
| 116 | top coating of the face, |
| 120 | adhesive coating (PSA), |
| 121 | adhesive coating, |
| 130 | release coating, |
| 150 | adhesion-free area, |
| 200 | linerless label, label, |
| 240 | label printer, |
| 401 | arranging a face, |
| 402 | applying water-based adhesive, |
| 403 | arranging adhesion-free areas, |
| 404 | ensuring pre-determined level of moisture, |
| 405 | drying the adhesive coating, |
| 406 | transferring the adhesive onto face material, |
| 407 | winding the material into linerless roll, |
| 560 | drying unit, |
| 561 | drying device, |
| 570 | linerless label roll, |
| 580, | coating unit for applying adhesive, |
| 590 | moisturizing unit for ensuring pre-determined level of |
| | moisture, |
| 611 | carrier material, |
| 611b | web material, |
| 612 | face unwinder, |
| 650 | cooling cylinder, |
| 660 | roll nip, and |
| 690 | adhesive removal unit. |

In this specification, the term “comprising” may be used as an open term, but it also comprises the closed term “consisting of”. Thus, unless otherwise indicated, the word “comprising” can be read as “comprising or consisting of”.

For the purpose of the present description and the claims, unless otherwise indicated, all ranges include any combination of the maximum and minimum points disclosed and include any intermediate ranges therein, which may or may not be specifically enumerated herein.

Unit of temperature expressed as degrees C. corresponds to ° C.

Percentage values relating to an amount of a material are percentages by weight (wt. %) unless otherwise indicated.

All percentage values relating to an amount of a material refer to dry weight, unless otherwise indicated.

Term “surfactant” refers to a surface active agent. The surface active agent(s) may comprise free surface active agents and non-free surface active agents.

The surface active agent(s) may comprise one or more than one surface active polymerization agent. The surface active agent(s) may comprise one or more than one wetting agent. The surface active agent(s) may comprise one or more than one emulsifier.

The term “surface active polymerization agent” refers to surfactant(s) used for a polymerization process of the water-based acrylic adhesive. The surface active polymerization agent may be a non-reactive surfactant. Preferably, the surface active polymerization agent is a reactive surface active polymerization agent. The reactive surface active polymerization agent may be, at least mainly, polymerized with monomers, and there may not be substantial amounts of free surfactants left in the formed adhesive coating. The reactive surface active polymerization agent can comprise a reactive double bond via which it may be copolymerized with monomers during the polymerization process.

The term “wetting agent” refers to a surfactant that is added after the polymerization process into the formed water-based acrylic adhesive for adjusting surface interaction properties and, e.g., decreasing surface tension of the water-based adhesive(s). The wetting agent may be a non-reactive surfactant. The water-based acrylic adhesive may or may not contain the wetting agent.

In this specification, the term “emulsifier” refers to a surfactant added after the polymerization process into the formed water-based acrylic adhesive for adjusting interaction properties of some particles. If the water-based acrylic adhesive comprises a silicone additive, the emulsifier may be a part of the silicone additive.

Term “web” refers to a continuous sheet of material. The web is generally processed by moving over rollers. Between processing stages, webs may be stored and/or transported as rolls.

In this specification, the term “linerless label web” refers to a continuous direct thermal web comprising a face 110 and pressure sensitive adhesive 120, wherefrom the linerless labels 200, i.e. the individual labels, may be separated. Conventional linerless label webs may not have the same challenges as the direct thermal linerless label webs due to the direct thermal coating therein, and the typical end use in on-demand printing.

In this specification, the terms “label”, “linerless label” and “adhesive label” refer to an individual direct thermal label product 200 separated from the direct thermal linerless label web 100 to be applied onto an article, unless otherwise indicated. The label 200 may be adhered onto an article by using an adhesive. Thus, in this application, the terms “label”, “linerless label” and “adhesive label” refer to a product comprising the direct thermal face 110 and the pressure sensitive adhesive coating 120, unless otherwise indicated.

The term “linerless label (web)” refers to the label 200 and/or to the linerless label web 100.

Term “machine direction” refers to manufacturing direction of a web. Machine direction may also refer to a circumferential direction of a roll. Further, longitudinal direction of a web refers to the machine direction. In this application, the term “first direction” refers to the machine direction.

Terms “cross direction” and “cross machine direction” and “transversal direction” refer to a direction that is transversal to the machine direction. In this application, the term “second direction” refers to the cross direction.

The term “face” refers to a substrate of the label, also called as a face stock or a face material. In this application, the face comprises a base layer, a direct thermal printable coating, and an intermediate layer between the base layer and the direct thermal printable coating. In an advantageous embodiment, the base layer is an uncoated paper.

In this application, the term “adhesive coating” refers to a coating comprising a water-based acrylic adhesive. The adhesive coating may further comprise e.g. a silicone additive.

The terms “adhesive layer” and “adhesive coating layer” refers to a layer of an adhesive, which layer may be a continuous or non-continuous layer. The adhesive layer may comprise adhesive areas such as, for example, adhesive stripes and/or adhesive spots.

The term “PSA” refers to pressure sensitive adhesive(s).

### Face

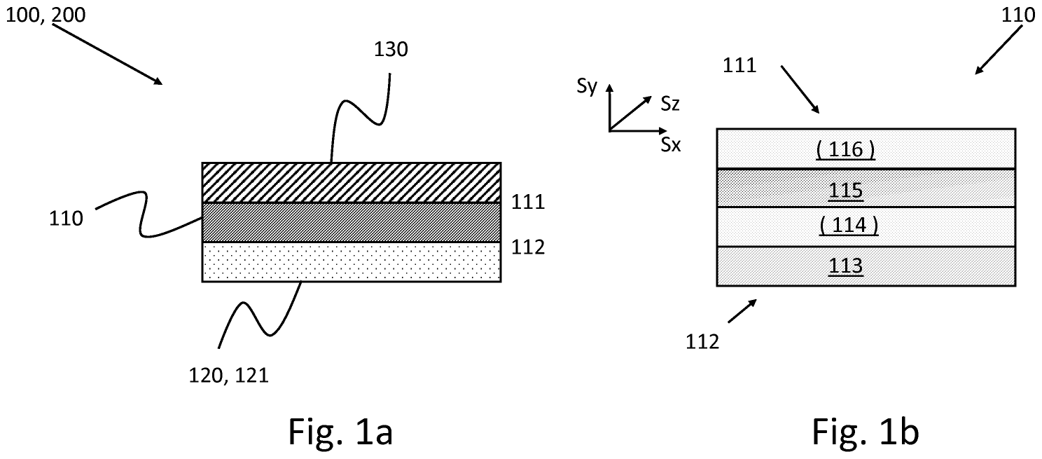

FIG. 1b illustrates, by way of an example, an Sₓ, S_{y}-cross-section of a face. The face 110 is the layer that is adhered to a surface of an article during labelling through an adhesive coating.

The face 110 comprises a first side 111 and a second side 112 (shown in FIGS. 1a-1b). The top side (first side 111) of the linerless label (web) can be printable by using heat. The second side 112 is an adhesive side.

The face 110 of the direct thermal linerless label web has at least two layers. The face comprises or consists of
a base layer 113, which can be a base paper or a filmic material,
a direct thermal coating layer 115,
optionally, an intermediate layer 114 left in between the direct thermal coating layer 115 and the base layer, and
optionally, a top coating 116.

The top coating 116 on the direct thermal coating layer 115 may be used to protect the thermal coating layer 115. The top coating may protect the direct thermal coating at least during a manufacturing process of the direct thermal linerless label web. The top coating may protect the top surface and/or print of the face against rubbing or other external stress. However, in an embodiment, the face does not have said top coating 116.

The top coating, if used, may comprise at least one of: starch, polyvinyl alcohol (PVA), latex, and wax. Preferably, the top coating comprises polyvinyl alcohol (PVA) and/or wax. These polymers may provide improved protection for the direct thermal printable coating. Furthermore, wax may improve friction properties of the linerless label web. The top coating may further help to decrease dusting of the linerless label web.

In addition to the top coating 116, or alternatively, the face may comprise, for example, one or more than back coating on the second side 112 of the face 110. The back coating(s) may comprise or be based on, for example, polyvinyl alcohol. The back coating may improve anchoring of the adhesive 120,121 to the face 110. In an embodiment, the face does not have said back coating layer but the water-based pressure sensitive adhesive 120 is directly in contact with base layer, without any further coating layers between the PSA and the base layer.

The linerless label (web) 100, 200 may further contain one or more barrier layers to prevent chemical substances from migrating through a surface of the first side 111 of the face or a surface of the second side 112 of the face, or other interfaces of the linerless label (web) 100, 200. In an embodiment, the linerless label web does not have said additional barrier layer.

Advantageously, for cost and environmental reasons, the base layer is an uncoated base paper having a grammage in a range between 38 g/m² and 82 g/m². A grammage of the face 110 is preferably at least 45 g/m², more preferably at least 50 g/m². Further, the grammage of the face is preferably less than 80 g/m², more preferably equal to or less than 75 g/m². Grammage may be, for example, in a range between 45 g/m² and 80 g/m² or in a range between 50 and 75 g/m². Said grammages can be particularly suitable for the linerless label comprising the direct thermal printable coating, and for use in on-demand linerless label printers. The grammage can be measured according to standard ISO536.

The face 110 may have a static sensitivity below 100 degrees C., preferably in a range between 75° C. and 95° C. The static sensitivity, as well as dynamic sensitivity, needs to be low enough so that the product is not darkening before printing, for example during transportation. However, the static and dynamic sensitivities should be high enough so that the linerless label (web) 100, 200 is thermally printable.

The face 110 may have a caliper in a range between 60 μm and 85 μm, measured according to ISO534. If the face it is too thin, the linerless label (web) 100, 200 may be difficult to handle. For example, if the face is very thin, a stiffness of the linerless label web may go too low causing the linerless label web to be too sloppy. Thus, the linerless label (web) may be difficult to manufacture and/or the linerless label (web) may cause problems when used with a linerless label printer.

As discussed, the base layer of the face 110 may comprise or consist of a paper. Alternatively, the base layer of the face 110 may comprise or consist of a filmic material. The filmic material may be made of polyethylene (PE), polypropylene (PP), or biaxially oriented polypropylene (BOPP). Also, other suitable materials, such as different types of polyesters such as polyethylene terephthalate (PET) or polyethylene(s) are possible.

Preferably, the base layer comprises or consists of the paper. Advantageously, the base layer consists of an uncoated paper.

The face 110 may comprise a paper comprising natural fibres as its main raw material. Natural fibres refer to any plant material that contains cellulose. The natural fibre may be wood based. The wood based natural fibre may be from softwood trees, such as spruce, pine, fir, larch, douglas-fir, or hemlock, and/or from hardwood trees, such as birch, aspen, poplar, alder, eucalyptus, or acacia, or from a mixture of softwoods and hardwoods.

The paper, if used, preferably comprises wood based natural fibres. The wood based natural fibres are preferably main fibre material of the paper. The face 110 may comprise cellulose fibers from hardwood and/or softwood. A mixture of hardwood and softwood may be used to improve the internal bond strength of the face 110.

The base layer can be so-called wood-free paper. Wood-free refers to chemical pulp, such as Kraft pulp. In accordance with an embodiment, a pulp used for making the face does not contain any kind of mechanical pulp due to high quality requirements of the face. The paper 113 of the face 110 may be the wood-free paper comprising fibers e.g. from softwoods and/or hardwoods.

The base layer 113, such as the uncoated base paper, may further comprise, for example, at least one mineral filler selected from a group comprising clay, calcined clay, kaolin, natural ground calcium carbonate, precipitated calcium carbonate, talc, calcium sulphate, and titanium dioxide. Total amount of the mineral fillers in the base layer 113 may be less than 18 wt. %, preferably less than 13 weight-%, more preferably less than 8 weight-%, and most preferably less than 5 weight-%, for example between 0 wt.-% and 4 wt.-%, based on the total weight of the base layer 113. The mineral fillers may decrease costs of the manufactured product. However, the mineral fillers may also decrease strength properties of the face 110. Further, if the base layer comprises too much fillers, some properties of the face 110 may be compromised. For example, mineral fillers may increase dusting of the face, which may cause blocking and other problems to on-demand printers. Dusting tendency of the direct thermal linerless label web may be decreased if amount of mineral fillers in the base layer is substantially low.

The uncoated base paper may have a fiber content of equal to or more than 50 wt. %, preferably at least 60 wt. %, and more preferably at least 70 wt. % in order to improve strength of the linerless label web. Further, increased content of natural fibres and decreased content of mineral fillers may decrease dusting of a base layer in on-demand printers.

The paper may be manufactured from FSC™-certified (mix credit) pulp. Thus, the face may comprise or consist of environmentally friendly material. Thus, the novel linerless label (web) may be better for the environment than some other kind of face materials.

Regardless the base layer being either fiber based or filmic, the composition of the intermediate layer 114, if disposed between the base layer and the direct thermal printable coating, is important in affecting the amount of dust when the linerless label material is cut and separated into labels in a thermal printer. It seems that the composition of the intermediate layer 114 has an effect on how an internal pressure becomes spread into the label material layers in the guillotine cutting operation. The composition of the intermediate layer seems to prevent the creation of the dust not only from the intermediate layer itself but also from the other layers of the label material. In case of filmic base layer, the structure of the intermediate layer 114 seems to minimize the pressure stress created in the guillotine to spread wider from the cut line into the label material and thus affecting smaller area around the cut line.

The base paper may be calendered with a calender or a supercalender to obtain a high-density surface.

The base layer 113 may be coated in order to form the intermediate layer 114 interposed between the base layer 113 and the direct thermal coating 115. A coat weight of the intermediate layer 114, if used, may be in the range of 0.9 to 7 g/m² per side, preferably in a range between 1 g/m² and 5 g/m², more preferably in a range between 1.3 g/m² and 4 g/m² and most preferably in a range between 1.6 g/m² and 3 g/m². Thanks to the intermediate layer, a quality of the direct thermal coating may be improved. Further, amount of expensive direct thermal coating needed to obtain good printable properties may be decreased.

The intermediate layer, if used, may comprise at least one mineral pigment. Preferably, amount of mineral pigments is substantially low in the intermediate layer. A mineral pigment content of the uncoated base paper may be equal to or less than 18 wt. %, more preferably equal to or less than 16 wt. % in order to decrease dusting tendency of the product. Alternatively, or in addition to the mineral pigments, the intermediate layer may comprise a non-mineral pigment. Further, amount of the binder(s) in the intermediate layer, if used, may be at least 15 wt. %, such as in a range between 20 wt. % and 50 wt. %, preferably in a range between 25 wt. % and 45 wt. %, more preferably in a range between 30 wt. % and 42 wt. %, and most preferably in a range between 33 wt. % and 40 wt. %, based on the total weight of the intermediate layer. The binders may be used to bind pigment particles together, in order to form an even coating layer. Further, the intermediate layer 114 may have an effect of reducing heat transfer from a thermal coating to the base paper 113. This may enable enhanced or high-resolution print to be formed.

Face: an example of a direct thermal printable coating

The face 110 comprises a direct thermal printable coating 115. Thus, the face 110 may be called a thermally direct printable face.

The direct thermal printable coating 115 is arranged to provide thermal printability for the face 110. The direct thermal printable coating is arranged to form a thermal sensitive, reactive layer changing color during the thermal printing. The thermal coating comprises reactive components. The thermal coating may comprise a matrix. The matrix may comprise a dye and a developer.

The thermal coating matrix in a solid state is heated by a thermal print head above its activation point and/or melting point. The dye of the thermal coating may comprise a leuco type dye. The leuco type dye is arranged to react with an acid and change into a colored form. Thermal coating may comprise a dye, a developer, a sensitizer, a binder, and a stabilizer.

The developer can be arranged to co-react with the dye above activation temperature during thermal printing. Reaction of the dye with the developer is arranged to trigger color formation. Developer may comprise sulfonyl ureas, zinc salts of substituted salicylic acids or phenols, for example Bisphenol S (BPS). The thermal coating may preferably be BPA free, Bisphenol (BP) free and/or Phenol free for increased chemical safety.

Sensitizer may be used in a thermal coating to decrease melting point of a dye and/or a developer. Dye and developer are arranged to react when heated above melting point of matrix of the thermal coating. The melting point of the matrix may depend on melting point values of its components. Thermal threshold of the thermal coating is melting point of the component of the thermal coating having the lowest melting point. Sensitizer of the thermal coating may be arranged to decrease melting point of dye and/or developer. This has effect of proving accuracy to the melting point and/or optimizing temperature of color change and/or facilitating mixing of dye and developer.

Optionally, the thermal coating may comprise stabilizers. Dyes in thermally sensitive paper may be unstable tending to return to their original colorless crystalline form. The thermal paper may be sensitive, for example, to hot and humid external conditions. In order to stabilize the metastable glass formed by leuco dye, developer and sensitizer, a stabilizer may be added to the mixture. Stabilizers may affect inhibiting recrystallization of the dye and developer and/or stabilizing the print.

Binder of the thermal coating may have an effect of facilitating the thermal coating to adhere to a base substrate or to a pre-coat. Binder may comprise double bonds. The binder may comprise polyvinyl alcohol (PVA) or latex, for example a styrene butadiene latex (SB) or a styrene acrylic (SA).

Sensitivity of the thermal coating refers to the degree to which it reacts to a given amount of heat or energy. Sensitivity is a decisive factor in the selection of the right thermal coating or thermal paper. It may be depicted in graphs plotting a curve of image density or optical density (OD) against the amount of heat or energy transferred. Optical density is a measure of a relationship between incident and reflected light. An optical density of approximately 1.1 is usually a full black to the human eye. Lower optical densities thus correspond to varying shades of grey. Thermal coatings and thermal papers are typically characterized by using static and dynamic sensitivity.

Static sensitivity indicates the temperature at which a thermal paper will begin imaging, i.e. changing color. Thermal papers with low static sensitivity only begin imaging at high temperatures, for example at above 90 degrees C. Thermal papers with medium static sensitivity on the other hand begin imaging at lower temperatures, for example at between 80 and 90 degrees C. High static sensitivity thermal papers start to react even at lower temperatures, for example at 65-80 degrees C., or at 70-80 degrees C.

Dynamic sensitivity of thermal papers indicates in practice how fast a thermal paper can be printed. This is especially relevant in the selection of the right thermal paper for a particular thermal printer, since the higher the dynamic sensitivity of the paper, the faster the printer can operate without any settings having to be changed. Dynamic sensitivity is typically indicated as mJ/mm². Thus, thermal papers with low dynamic sensitivity require higher print head temperature and/or longer exposure, i.e. slower printing speed to achieve high optical density of the image. On the other hand, high dynamic sensitivities allow faster printing even with lower print head temperatures.

Dynamic sensitivity is challenging to categorize by using unambiguous, single numerical values (for example energy levels in mJ/mm²) into low, medium, and high categories because the total energy level delivered into the paper does not directly correspond to a certain temperature reached in the thermal coating. The heat capacity of the thermal paper is related, for example, to the thickness of the paper and existence of different material or material layers. Thus, different amount of energy may be needed to heat papers having different thicknesses to the same temperature. Different paper thicknesses or thermal conductivity of various layers may cause different temperature levels in the thermal coating.

For example, at optical density 1.1 (full black for a human eye) very different energy levels may be required to reach such full color change in the thermal coating layer. A high dynamic sensitivity thermal paper may reach such optical densities already at energy levels below 15 mJ/mm², a medium dynamic sensitivity may require something around 20 mJ/mm², for example energies in the range of 15-25 mJ/mm², and a low dynamic sensitivity thermal paper may require energy levels even above 25 mJ/mm² for the same darkness of the print. Each of these papers may still start to have some color change in much lower energy levels, for example, already below 10 mJ/mm².

High static sensitivities may be preferred combined with high dynamic sensitivity allowing fast printing with economic and simple linerless printers. Temperature of the surface of a labelled item is not likely to exceed 65-70 degrees C., which allows the use of some thermal papers with medium static sensitivity, and more preferably thermal papers with high static sensitivity approaching those maximum surface temperatures of the labelled items. On the other hand, long term stability is not an issue in these short-lived applications making it possible to use more economical thermal papers which are not designed specifically for archiving or longer-term stability. Such high static and dynamic sensitivity of the thermal coating/paper may place challenges in manufacturing of the direct thermal printable linerless labels because it sets limit to the highest temperatures that the direct thermal face material can be exposed to during manufacturing of the linerless label product in order to prevent unwanted and premature color changes of the thermally sensitive coating.

### Aqueous Polymer Emulsion

The water-based acrylic adhesive coating 121 may be based on an aqueous, i.e., water-based, polymer emulsion. The aqueous polymer emulsion can be based on acrylic polymer.

Aqueous polymer emulsion may have relatively low cost, ease of application and relatively low amounts of volatile organic compounds (VOC) contained therein. Further, water-based polymer emulsion can be suitable for use in food applications. The water-based polymer emulsion may be suitable and approved for direct food contact.

The aqueous polymer emulsion may comprise an acrylic-based copolymer. The term “copolymer” refers to a polymer prepared from more than one monomers of different species.

In an embodiment, an amount of the acrylic-based copolymer may be from 40 to 65 wt. %, or from 45 to 60 wt. of the emulsion weight.

The aqueous polymer emulsion, which may be an acrylic-based copolymer, may be derived from components comprising
1) acrylate monomer(s),
2) vinyl aromatic compound(s), and
3) surfactant(s), i.e., surface active polymerization agent(s).

Further, the components can comprise chain transfer agent(s).

Acrylate monomers, in general, can be based on the structure of acrylic acid, which consists of a vinyl group and a carboxylic acid ester end or a nitrile.

In an embodiment, the aqueous polymer emulsion comprises the following amounts of the acrylate monomers (by dry weight): from 0 to 5 wt. % acrylic acid, from 0 to 5 wt. % methacrylic acid, from 0 to 5 wt. % β-carboxyethyl acrylate, from 0 to 15 wt. % methyl acrylate, and from 0 to 90 wt. % 2-ethyl hexyl acrylate. With these amounts of acrylate monomers, it is possible to provide an improved aqueous polymer emulsion for the adhesive coating 121. In an advantageous embodiment, amount of the 2-ethyl hexyl acrylate is at least 50 wt. %.

The aqueous polymer emulsion may comprise a total amount from 85 to 99 wt. % (by dry weight) monomers comprising the acrylate monomer(s) and vinyl aromatic compound(s). The aqueous polymer emulsion may comprise from 0.1 to 10 wt. % of vinyl aromatic compound(s) (by dry weight). The vinyl aromatic compound(s) may comprise or consist of alpha-methyl styrene or styrene. This kind of acrylic-based copolymer may provide improved properties for the linerless label web.

The polymerization can be carried out in the presence of one or more than one surface active polymerization agent(s). The surface active polymerization agent(s) may comprise a reactive surfactant and/or a non-reactive surfactant.

In general, role of surface active polymerization agent(s) in the polymerization process is to form micelles and to emulsify monomers. For this, a surfactant having a hydrophilic part and a hydrophobic part may be preferred. The surfactant can emulsify and disperse the polymer particles.

The reactive surface active polymerization agent(s) may contain components which are capable of acting as an internal crosslinker during the polymerization process. Said components may have polymerizable double bonds. The reactive surface active polymerization agent(s) can, hence, be capable of reacting with acrylic monomers. Therefore, the reactive surface active polymerization agent(s) can comprise a reactive double bond via which it may be copolymerized with the monomers.

According to an embodiment, at least one reactive surface active polymerization agent is an anionic surfactant.

The polymer emulsion may comprise, for example, from 0.1 to 5 wt. % (by dry weight) surface active polymerization agent(s). In an advantageous embodiment, the polymer emulsion comprises from 0.5 to 4 wt. % (by dry weight) surface active polymerization agent(s), more preferably from 1 to 3 wt. % (by dry weight) surface active polymerization agent(s), and most preferably from 1.5 to 2.5 wt. % (by dry weight) surface active polymerization agent(s). In an advantageous embodiment, the surface active polymerization agent(s) is, at least mainly, polymerized with monomers, and there may be only residual free surfactants left in the water-based acrylic adhesive 121.

Therefore, thanks to the reactive surface active polymerization agent(s), if used, there may not be free surfactant left in the system after the polymerization process. Alternatively, there may be some small residual free surfactant left in the system after the polymerization process. Thanks to the very small amount of free surfactants after the polymerization process, the formed water-based adhesive coating may comprise diminished amount of free surfactant(s). Therefore, the formed water-based acrylic adhesive coating may be dried, substantially easily, into the pressure sensitive adhesive.

In addition, or alternatively to the reactive surfactant, the surfactant(s) may comprise a non-reactive surfactant. However, reactive surfactants may be preferred because non-reactive surfactants may stay free in the polymerization process and, hence, they may cause some problem for the formed linerless label web.

The aqueous polymer emulsion may comprise a chain transfer agent. The polymer emulsion may comprise, for example, from 0.005 to 0.5 wt. % (by dry weight) the chain transfer agent. The chain transfer agent may be responsible for controlling average polymer chain length of the acrylic-based copolymer. Thanks to the chain transfer agent, adhesion performance may be improved. In an embodiment, the chain transfer agent is n-dodecyl mercaptane (n-DDM), or t-dodecyl mercaptane (t-DDM).

### Adhesive Coating

The adhesive coating according to this specification is a water-based acrylic adhesive coating.

As discussed above, in an embodiment, there may not be free surfactants (i.e., free surface active polymerization agents) left in the polymer emulsion after the polymerization process.

However, one or more additional surfactants have conventionally been added into the aqueous polymer emulsion before the formed water-based acrylic adhesive has been applied onto a face. For example, an amount of 1 to 2 wt. % of wetting agents has thought to be a necessary component for water-based acrylic adhesives, because wetting agents increase spreading and penetrating properties by lowering a surface tension. A person skilled in the art is familiar with wetting agents.

Therefore, some surfactants may be added as additives to the aqueous polymer emulsion before the formed water-based acrylic adhesive is applied and dried into the pressure sensitive adhesive coating 120.

In an advantageous embodiment, total content of free surfactant(s) is equal to or less than 1 wt. % (by dry weight), preferably equal to or less than 0.6 wt. % (by dry weight), more preferably equal to or less than 0.5 wt. % (by dry weight), and most preferably equal to or less than 0.3 wt. % (by dry weight), determined from total dry weight of the water-based acrylic adhesive 120, 121. Reduced free surfactant content may have a technical effect providing that the surfactants are being substantially uniformly dispersed in the formed adhesive, and the formation of segregated hydrophilic islands may be avoided or at least diminished. Thus the formed PSA composition may not show unwanted peeling, i.e. delamination. The acrylic adhesive composition including reduced free surfactant content may have an effect on providing increased, i.e., improved, initial tack for the label especially when the surface to be labelled is polar. Polar surfaces include glass, steel and PET.

Thus, as discussed, use of reduced free surfactant content may provide improved peel adhesion. High peel adhesion may be important for label stability on a substrate. High peel adhesion may prevent detachment at the label (corners) under humid conditions, transportation and during consumer usage of the labelled item.

In an embodiment, surfactant(s) added into the adhesive coating as additives may comprise wetting agent(s). Surprisingly, water-based acrylic adhesives without wetting agents, or with very low amount of wetting agents, may provide many benefits in various phases of the manufacturing process as well as during converting stage and for an end use. Further, these effects can be improved by using an optimized coating thickness.

A dosage of the wetting agent(s) may be equal to or less than 0.3 wt. %, preferably equal to or less than 0.2 wt. %, more preferably equal to or less than 0.1 wt. %, down to 0 wt. %, calculated from the total dry weight of the water-based acrylic adhesive coating. Most preferably, the adhesive coating does not comprise the wetting agent at all. Surprisingly, the wetting agent, if used a dosage of more than 0.3 wt. % (by dry weight) and particularly if used a dosage of more than 0.5 wt. % or more than 0.6 wt. % (dry weight from the adhesive coating), was found to cause decreased drying efficiency as well decreased printing quality. The greater the dosage, the faster the printing quality changes. Thus, more wetting agent may mean worse printing quality.

In an embodiment, the water-based acrylic adhesive comprises wetting agent(s). In this embodiment, the wetting agent(s) is/are preferably anionic or nonionic, most preferably anionic. By using small amount of less than 0.3 wt. %, preferably equal to or less than 0.2 wt. % wetting agent(s), an evenness of PSA layer may be improved without decreasing too much other properties.

FIG. 10a shows an example of a printing quality with 0.2 wt. % dosage of wetting agent, after aging the direct thermal linerless label 12 weeks. FIG. 10b shows an example of a printing quality with 0.5 wt. % dosage of wetting agent, after aging 12 weeks. It is clearly visible that the greater dosage of the wetting agent can mean worse printing quality. With a dosage of at least 0.3 wt. %, printing quality can start to decrease after aging the linerless label web only two to three weeks.

FIG. 10c shows an example of a printing quality with 1.3 wt. % dosage of wetting agent after aging 7 weeks. FIG. 10d shows an example of a printing quality with 1.3 wt. % dosage of wetting agent after aging 9 weeks. Significant quality changes in printing may occur after 9th weeks for dosages of more than 0.3 wt. %, and already after 7th week for dosages of around 1 wt. %.

In order to improve drying of the water-based acrylic adhesive as well as improve printing quality of aged direct thermal linerless label webs, a total content of free surfactant(s) in the water-based acrylic adhesive coating), excluding surface active polymerization agent(s), may be in a range between 0 and equal to or less than 0.6 wt. % (by dry weight), preferably equal to or less than 0.5 wt. %, more preferably equal to or less than 0.4 wt. %, and most preferably equal to or less than 0.3 wt. %, such as in a range between 0.01 and 0.5 wt. % (by dry weight). Thanks to the very small amount of free surfactants in the water-based adhesive coating, the water-based acrylic adhesive coating may be dried, substantially easily, into the pressure sensitive adhesive. Furthermore, due to the small amount of free surfactants, printing quality of aged direct thermal linerless label webs may be improved.

The adhesive coating may comprise a tackifier. Tackified acrylic adhesives may be used to provide aggressive adhesion to a surface. The tackifier is an optional component. The tackifier, if used, is preferably added in a form of an aqueous dispersion. In an embodiment, the tackifier is selected from a group comprising rosin esters, terpene resins, phenol resins, rosin resins and rosin derivative resins, petroleum resins, and ketone resins. Compatibility between a tackifier (if used) and an adhesive coating may be an important factor for improving properties of the adhesive coating. In an embodiment, a tackifier is selected in a group comprising rosin resins and rosin derivative resins. These tackifiers may be used for improving an adhesion and tack of the pressure-sensitive adhesive.

The adhesive coating may comprise an emulsified silicone additive. Thanks to the emulsifier of the emulsified silicone additive, the silicone additive may not float in the water, but the silicone additive can be mixed (i.e., “dissolved”) in the water-based solution. The silicone additive in the adhesive coating 120, 121 may improve the easiness of cutting of the label material, particularly with an on-demand linerless label printer. Furthermore, thanks to the said improved easiness of cutting, the silicone additive in the adhesive coating 120, 121 may also decrease amount of dust in on-demand printers.

The water-based acrylic adhesive may or may not comprise the silicone additive. If the adhesive layer comprises the silicone, amount of emulsified silicone additive in the adhesive layer may be equal to or more than 1 wt.-%, more preferably equal to or more than 1.5 wt. %, and most preferably equal to or more than 2 wt. %, calculated from the dry weight of the adhesive coating layer. This grammage may provide an improved usability of the linerless label for printers. Further, the amount of the emulsified silicone additive can be equal to or less than 6 wt. %, more preferably equal to or less than 5 wt. %, and most preferably equal to or less than 4 wt. %, calculated from the dry weight of the adhesive coating layer. Thus, it may be possible to obtain cost effective solution having good adhesive properties. The amount of the emulsified silicone additive on the adhesive layer may be, for example, between 1 to 6 wt. %, or between 2 wt. % and 4 wt. %, calculated from the dry weight of the adhesive coating layer. The silicone additive, if used, may be added into the adhesive coating by adding silicone emulsion into acrylic water-based adhesive, thereby forming the adhesive coating 121. Silicone emulsion may modify the adhesive performance so that immediate adhesion for very quickly moving metallic blade in the printer/labelling process is significantly decreased.

### Pressure Sensitive Adhesive Coating

During a manufacturing process of the linerless label (web) 100, 200, an adhesive coating 121 is dried into a pressure sensitive adhesive coating 120. Therefore, obtained linerless label (web) has the pressure sensitive adhesive coating on its surface.

The label 200 and the linerless label web 100 disclosed herein comprise a pressure sensitive adhesive coating, which adhesive coating 120 is arranged on the second side 112 of the face 110. The pressure sensitive adhesive coating 120 may also be called a self-adhesive coating.

The pressure sensitive adhesive coating layer 120 may comprise one or more layers of water-based adhesive. If the PSA coating 120 comprises more than one layer of adhesive, the adhesive coating may have improved smoothness. For example, if the first adhesive coating layer comprises any small holes, these may be filled with the second adhesive coating layer.

The PSA may be permanent adhesive, or it may be removable or repositionable, or even ultra-removable. The PSA may have a working temperature from ambient to freezer temperatures.

The pressure sensitive adhesive may be used for permanent linerless label (web) or removable linerless label (web). For removable linerless label (web), the maximum tack value may be between 0.5 N and 6 N measured on glass according to FINAT test method FTM9. Said values may be particularly suitable performance values for the pressure sensitive adhesive coating 120 of the direct thermal linerless label (web) 100, 200 for quick service restaurants.

For permanent linerless label (web) having acrylic adhesive, the maximum tack value may be equal to or more than 2 N, more preferably equal to or more than 8 N, and most preferably equal to or more than 10 N, measured on glass according to FINAT test method FTM9. Said values may be particularly suitable performance values for the pressure sensitive adhesive coating 120 of the direct thermal linerless label (web) 100, 200 for industrial food or retail labeling. Further, values of equal to or more than 10 N may be particularly suitable performance values for the pressure sensitive adhesive coating 120 of the direct thermal linerless label (web) 100, 200 for logistic and warehouse.

Water-based adhesives can provide better sustainability with less fossil based raw materials and less volatiles involved both during the manufacturing and during end use. Further, it may be easier to achieve a good anchorage level with water-based PSA onto the face 110 disclosed herein even without any additional primer being used. Furthermore, the reduced amount of wetting agents may further improve the anchorage level. In an embodiment, the water-based pressure sensitive adhesive 120 is directly in contact with the face 110, such as the base layer of the face, without any further coating layers between the PSA and the face. This may be particularly advantageous embodiment without wetting agent(s) or with reduced amount of wetting agent(s).

Water-based adhesives according to this specification may be designed to have approval for direct or indirect food contact (food-safety), which is a requirement in certain food related label end use areas.

The pressure sensitive adhesive according to this specification can be suitable for high coating speeds. Preferably, the adhesive gives reticulation free coatings at coat weights of 10-30 g/m² (dry coat weight). The adhesive may be plasticizer-free and may be used on thermal papers (including economy grades) without issues of premature image development or image fade. Thus, the adhesive coating 120 may be plasticizer-free. This may have several advantages as plasticizers may migrate into the product and cause some problems. For example, food safety might be compromised.

The water-based acrylic PSA may have many advantages over other kinds of PSAs. Water-based acrylic PSA may be very environmentally friendly. Further, tackiness of the product may improve thanks to the water-based acrylic adhesive. Further, hot melt adhesives may cumulate more easily into cutting machines than water-based acrylic adhesives and, furthermore, increase amount of dust in said machines. Moreover, peel values of the acrylic based adhesive typically differ from peel values of the hotmelt based adhesives.

Still further, acrylic adhesives may have a longer open time, hence, linerless label (web) comprising water-based acrylic PSA may be removed after some seconds or minutes, if needed. On the contrary, hot melt adhesives cannot typically be removed from a surface, even if attached onto a wrong surface. Thus, removability of the water-based acrylic adhesive may be better than removability of the hot melt adhesives.

Furthermore, for example water-based acrylic adhesives having less than 0.3 wt. % wetting agents in the adhesive coating 120, 121 may significantly reduce adhesive accumulation to rolls and other parts of a web guide of the linerless printer. A reduced amount of free surfactants may protect the linerless label printer, e.g., because the adhesive can be properly dried and, hence, firmly attached to the face. The reduced wetting agent content may significantly reduce adhesive accumulation to a guillotine blade of an on-demand printer, particularly when total amount of wetting agents is less than 0.3 wt. % (by dry weight), preferably equal to or less than 0.2 wt. % (by dry weight). Further, dust accumulation to a guillotine blade of an on-demand printer may be decreased.

The pressure sensitive adhesive layer 120 may have a coat weight in a range between 10 and 30 g/m² (dry coat weight). Preferably, the adhesive layer 120 has a coat weight of equal to or less than 25 g/m² (dry coat weight), more preferably equal to or less than 21 g/m². Thus, an adhesive layer that is good enough to attach the linerless label to the surface of an item without being too expensive can be obtained.

The pressure sensitive adhesive coating 120 of the produced linerless label (web) 100, 200 may have a thickness of at least 10 μm, preferably at least 12 μm or at least 14 μm, and most preferably equal to or more than 16 μm. The coat weight of the PSA may need to be high enough to fill the pores of the surface. Thus, the thickness of the PSA may depend on the surface to be coated. Further, the amount of the PSA needs to be high enough to attach the label onto the surface of an object. Advantageously, said thickness of the pressure sensitive adhesive coating 120, 121 is equal to or less than 40 μm, preferably equal to or less than 30 μm, more preferably equal to or less than 25 μm, and most preferably equal to or less than 20 μm. The thickness of the adhesive layer may be, for example, between 12 and 25 microns. Therefore, it is possible to obtain an adhesive layer that is good enough to attach the linerless label to a surface of an item without being too expensive.

The linerless label adhesive coating according to this specification may be used for minimizing adhesive accumulation to a cutter blade, rolls, and web path in linerless printers. Thus, the label may be easily cut so that the adhesive is not attaching to the printer but stay with the face.

In an embodiment, the reduced amount of less than 0.3 wt. %, preferably equal to or less than 0.2 wt. %, wetting agents may help to prevent a linerless label printer 240 from an accumulation of the adhesive to a blade and rolls of the linerless label printer and also prevent or at least diminish some dusting related problems. Said accumulation of the adhesive and dust might result shortened printer service cycle. Thus, printer service cycle may be improved. Furthermore, the reduced amount of less than 0.3 wt. %, preferably less than 0.2 wt. % wetting agents can improve drying step, hence, the adhesive coating according to this specification may be used on thermal papers (including economy grades) without issues of premature image development or image fade.

Furthermore, it might be easier to achieve good anchorage with water-based acrylic PSA onto the substrate, in some cases even without any additional primer being used.

### Adhesive Coating Layer

The adhesive coating layer may be a continuous layer or a non-continuous layer.

Thus, the adhesive coating layer of the linerless label web may be a continuous adhesive layer, wherein the adhesive coating layer does not have any adhesion-free areas.

Alternatively, the adhesive coating layer of the linerless label web may be a non-continuous adhesive layer. The non-continuous adhesive layer can comprise adhesive areas and adhesion-free areas. Advantageously, the adhesive coating layer comprises one or more adhesive areas and one or more adhesive free areas.

The adhesive coating layer may comprise or consist of, for example, adhesive stripes and/or adhesive spots and/or other shaped adhesive areas.

The adhesive coating layer may comprise, for example, at least one of:
straight continuous stripes,
positionally alternating continuous stripes, and
patched pattern gumming.

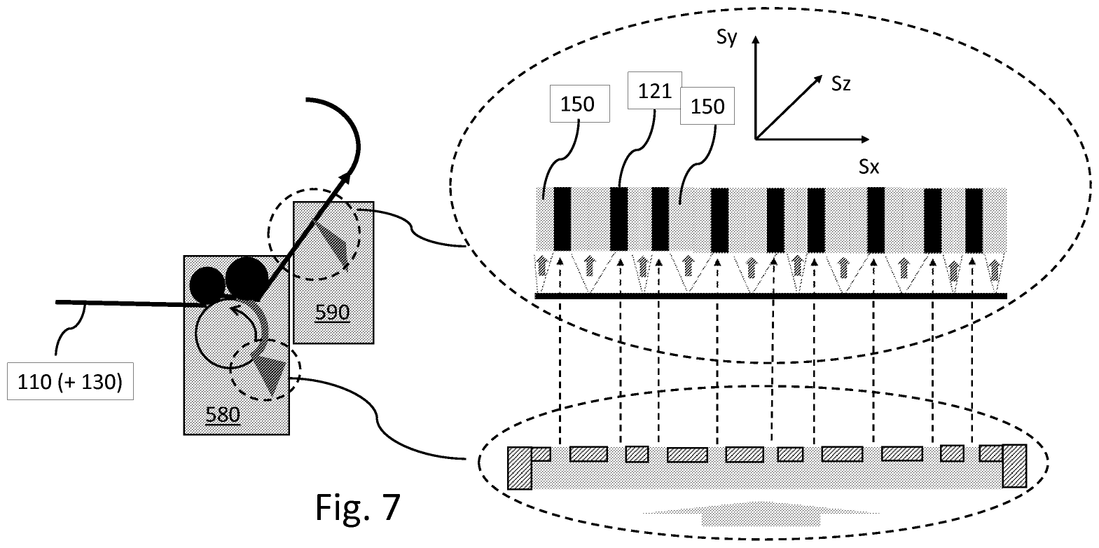

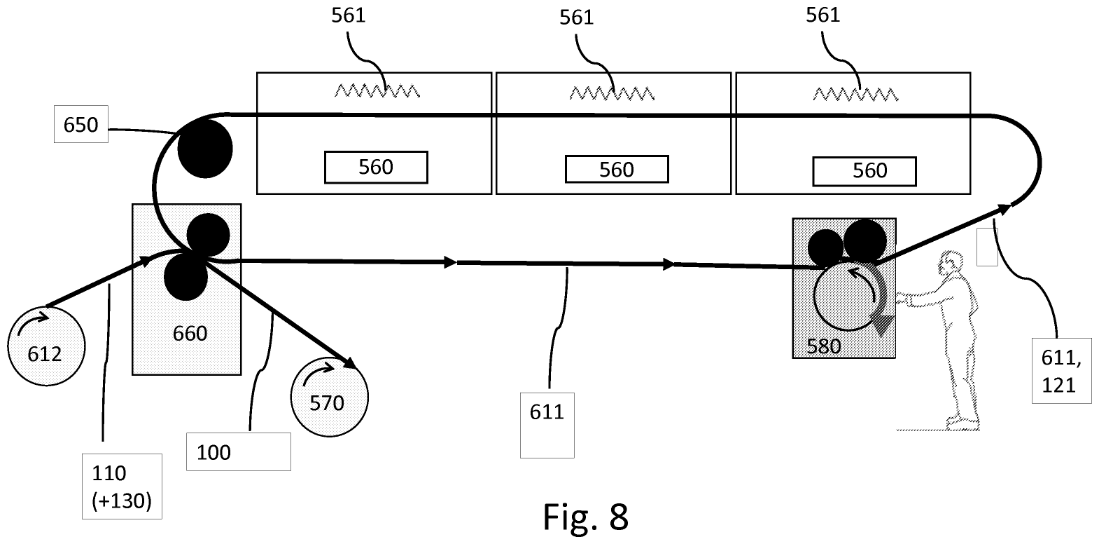

The adhesive coating layer 120, 121 may be a patterned coating layer as shown e.g. in FIGS. 6 and 7. By arranging adhesive coating 120, 121 in stripes in the longitudinal direction of the label web 100 (i.e. the first direction), performance of the linerless label web 100 in the on-demand printer as well as the manual handling of the label after printing may be significantly improved. The adhesive stripes may be in a form of straight continuous stripes, or in a form of alternating continuous stripes.

The patterned coating may be particularly advantageous when used together with reduced (e.g. from less than 0.3 wt. % to down to 0%) dosage of wetting agent(s). Thus, bleeding may be diminished or avoided while printing quality may be significantly improved.

In an embodiment, total coverage of the adhesive coating may be equal to or less than 90%, preferably equal to or less than 80%, calculated from the total area of the second side of the face. In addition, the total coverage of the pressure sensitive adhesive coating may be equal to or more than 10%, more preferably equal to or more than 30%, and most preferably equal to or more than 40%, calculated from the total area of the second side of the face. Said total coverage of the adhesive coating according to this specification may prevent bleeding of the adhesive in the label roll and aid keeping the printer mechanics clean of adhesive and dust.

For some end uses, it may be essential to leave continuous adhesion-free areas/stripes 150 near the longitudinal edges of the label web 100. These adhesion-free areas/stripes 150 near/on the longitudinal edges may correspond to minimum of 10%, or minimum of 20% of the total width of the label web 100. The non-adhesive area on the outer edges of the label may prevent any bleeding of the adhesive in the label roll and aid keeping the printer mechanics clean. The adhesion-free areas may be arranged symmetrically or nearly symmetrically on both longitudinal edges of the label web 100. Thus, it may be possible to ease travel of the label inside the printer and/or to help to be able to grip the labels with fingers not touching the sticky PSA. Whether the width of the adhesion-free areas 150 is selected to be symmetric or non-symmetric, the narrowest areas on either longitudinal edge of the label web 100 may correspond to minimum of 10% of the total width of the label web 100.

The adhesion-free areas/stripes 150 near (or on) the longitudinal edges of the label web 100 may have a width in a range between 10 and 25 mm. This may provide good balance between tack and manual handling and most importantly, provide good long term performance in the compact, on-demand linerless printers. The non-adhesive area 150 on the outer edges of the label may further prevent any bleeding of the adhesive in the label roll and aid keeping the printer mechanics clean. It is to be noted that the adhesion-free areas may, in some embodiments, comprise a residual amount of the adhesive coating.

Thanks to the water-based acrylic adhesive coating according to this specification, many advantages may be obtained. The adhesive coating layer may be easily cut through mechanically, with less adhesive residue left on the cutting blade or edge. Thus, this may reduce an accumulation of the adhesive coating to a linerless label printer. Said accumulation of the adhesive might result more dusting related problems as dust can be adhered together with the adhesive to the printer and, hence, result shortened printer service cycle. Thus, dusting related problems may also be diminished. Further, the acrylic water-based adhesive may be environmentally friendly adhesive, which may be used e.g. with food materials. Further, the acrylic water-based adhesive may have a longer open time, hence, linerless label (web) comprising water-based acrylic PSA may be removed after some seconds or minutes, if needed.

### Release Coating

The direct thermal linerless label (web) may have a release coating 130 on the first side 111 of the face 110, i.e., top of the face 110, as illustrated in FIG. 1a.

The linerless label web 100 with pressure sensitive adhesive 120 on its one side (bottom side) and release coating 130 on its other side (top side) can be self-wound around itself without tendency of blocking the adjacent layers of the label web 100 to each other. Thermal printing of the linerless label (web) 100, 200 may be made through the release coating 130.

The release coating 130 may be directly on the direct thermal coating. Alternatively, the release coating may be on a top coating 116 of the face.

The release coating 130 may be a silicone-based or non-silicone-based release coating. Preferably, the release coating comprises or consists of silicone-based release coating. Non-thermally curable release coatings are preferable, for example UV curable silicone, because curing of such layers may not heat the thermally sensitive materials in the thermally direct printable face 110. Thus, the release coating may be UV curable silicon having the benefit of being curable on top of thermal face without heat.

The release coating 130 may comprise one or more layers of release coating 130. Thanks to the release coating, the adhesion may be low enough so that the adhesive layer can be readily released from the face material upon unwinding the linerless label product roll.

The release coating 130 may further provide a lower friction level against the print head of the on-demand printer and/or against other mechanical components of the on-demand printer, thus minimizing wear of those components and minimizing adhesive residue built up. Thus, in an example, the release layer 130 is used in order to lower friction against the print head of the printer.

### Linerless Label

A label 200 (also called as a linerless label or a label product) is a piece of material to be applied onto an article. Articles of different shapes and materials may be used together with the labels 200. A label 200 comprising pressure sensitive adhesive may be referred to as a pressure sensitive adhesive label. Pressure sensitive adhesive labels may also be referred to as self-adhesive labels.

The labels 200 comprising PSA can be adhered to most surfaces through an adhesive layer without the use of a secondary agent, such as a solvent, or heat to strengthen the bond. In that case, the adhesive is pressure sensitive as such. Alternatively, the adhesive may be activatable in order to be pressure sensitive. The PSA forms a bond when pressure is applied onto the label at ambient temperature (e.g. between 15 and 35° C.) or for cold applications even under freezing temperatures below 0° C., adhering the label to the item to be labelled. Examples of pressure sensitive adhesives include water-based (water-borne) PSAs, solvent based PSAs, and hot-melt PSAs.

There are different kinds of labels in the market. A label may be the linerless label 200. A label may be a so-called shrink label, where heat shrinkable polymeric face material(s) are seamed and rolled on or sleeved around labelled articles and shrunk around the items. Shrinkable labels may comprise additionally some pressure sensitive adhesive(s) or those may be produced completely without pressure sensitive adhesive, or even without seaming adhesive. Further, the label may be an activatable linerless label, wherein the adhesive is activatable to be pressure sensitive, using for example additional heat, moisture or other activation means.

In this application, the pressure sensitive adhesive is water-based acrylic PSA. Said PSA can have inherent pressure sensitivity without need for separate activation before being able to be dispensed onto an article to be labeled.

Further, the label can be a linerless label which is attached onto the labelled item primarily via the pressure sensitive adhesive covering at least partially the bottom side of the label. The linerless label (web) of the invention is of the tape-type, in other words it can be self-wound onto itself in a roll without need for additional release liner.

Labels may be used in wide variety of labelling applications and end-use areas, such as labelling of food, home and personal care products, industrial products, pharmaceutical and health care products, beverage and wine bottles, other consumables etc. Labels enable providing information, like product specification, on the labelled product(s). Information, e.g. print of a label, may comprise human-readable information, like image(s), logo(s), text, and/or machine-readable information, like bar code(s), QR (Quick Response) code(s).

One important subcategory of labels using direct thermal printable face materials are so-called Variable Information Print (VIP) labels. These labels are at least partly printed just before dispensing them onto the item to be labelled and carry product specific information on that individual item to be labelled. VIP labels are used, for example, in retail weighting scales for fruits, vegetables, meat and other items sold per weight. Other labels which are individually printed per need are different type logistic labels containing shipment or product specific information, bus or train tickets or other tickets etc.

In an advantageous example, the linerless label consists of
a direct thermal face,
a release coating on the first side 111 of the face, and
a water-based acrylic adhesive on the second side 112 of the face.

### Linerless Label Web and Linerless Label Roll

As discussed, the linerless label web 100 refers to structure comprising a continuous face 110 and an adhesive 120 arranged on one side of the face 110. A linerless label web 100 is generally processed by moving over rollers. Between processing stages, the label web 100 may be stored and transported as rolls. From the linerless label web 100, individual labels 200 may be cut.

Width of the linerless label web, before cutting into customer rolls, is typically a multiple of the final customer roll width. The width of the web, before it is cut into customer rolls, may be, for example, from 1 to 3 meters. Afterwards, the wider web width of the machine roll produced in this manufacturing process may be to be slit into a correct customer roll width, for example having a width of at least 10 mm, preferably from 20 to 100 mm, or from 40 to 100 mm. Quite commonly used widths are between 40-60 millimeters.

The linerless label (web) may have a PPS10 roughness in a range between 0.9 μm and 1.5 μm, preferably in a range between 0.9 μm and 1.3 μm, and most preferably in a range between 0.9 μm and 1.2 μm determined from the top surface of the linerless label (web) according to ISO standard ISO 8791-4. For example, by using a face comprising a paper, if the paper is too rough, the life of a print head may decrease too much.

The linerless label (web) may have a brightness higher than 85% (R457) when measured according to standard ISO2469. Therefore, the linerless label may look nice. Further, high brightness may create a contrast between the symbols/letters. Thus, if the letters comprise machine-readable letters, the letters may be easily read thanks to said brightness.

The linerless label (web) may have an opacity higher than 80%, such as in a range between 80 and 90, when measured according to standard ISO2471. Thanks to said opacity, the surface of the linerless label may not be too transparent for a machine, or a human eye, to read.

The linerless label (web) may have a tensile strength in the machine direction (i.e., the first direction) higher than 40 N/15 mm, preferably higher than 45 N/15 mm, when measured according to standard ISO1924/2. Thus, dimensional stability of the linerless label (web) may be improved, which may have a positive effect on manufacturing process and printing process.

The linerless label (web) may have a tensile strength in the cross direction (i.e., the second direction) higher than 28 N/15 mm, when measured according to standard ISO1924/2. Thanks to said strength, a dimensional stability of the linerless label may be improved, which may affect manufacturing process and printing process.

Stiffness of the linerless label web may be in a range between 0.15 mNm and 0.30 mNm, determined in the machine direction MD of the linerless label web. Stiffness of the linerless label web can be measured according to ISO standard ISO 2494. Thanks to said stiffness range, stiffness of the linerless label web is not too low, which may cause the linerless label web to be too sloppy. Thus, the linerless label web may not cause too many challenges when used with a linerless label printer. Furthermore, thanks to said stiffness, functioning of a guillotine in linerless printers and easiness of a cutting process therein may be improved, which may further decrease dusting caused by the cutting process. Thus, a combination of said stiffness, the intermediate layer, and the acrylic adhesive may significantly reduce dust and adhesive accumulation to a guillotine blade of an on-demand printer. In an embodiment, stiffness of the linerless label web is in a range between 0.05 mNm and 0.20 mNm, determined in the cross direction of the linerless label web.

The linerless label (web) 100, 200 may comprise at least one, preferably all properties from a group consisting of:
Face has at least two layers comprising a base layer, and a direct thermal coating.
Face with static sensitivity below 100 degrees C., preferably below 95 degrees C. but however above 65 degrees C. This may ensure that thermal printing can be performed with reasonably low energy levels and high speed in the thermal printer but at the same time prevents the thermal paper undergoing unwanted activation during manufacturing and logistics.
Coat weight of adhesive layer 120 is in the range of 10-25 g/m² (dry coat weight) in order ensure both; good anchorage to the thermal paper and good tack to different type of surfaces.
Adhesive layer 120, 121 comprises acrylic based PSA. The adhesive layer may have a wetting agent content of less than 0.3 wt. %. Such acrylic based adhesives are more environmentally friendly and also provide more suitable temporal build-up of the final tack helping to reduce contamination of the printer. Still further, such acrylic adhesives may have a longer open time, hence, linerless label (web) comprising water-based acrylic PSA may be removed after some seconds or minutes, if needed.
Bleeding related problems may be avoided or diminished.
Dusting related problems may be avoided or diminished.
Adhesive layer 120, 121 has at least one adhesive area and may have at least one adhesion-free area. This ensures suitable label behavior per given end use but also helps to reduce the contamination of the printer.

### Linerless Label Printers

The general properties of the on-demand compact printers are discussed to clarify the requirements for the label product. In labelling process, the linerless label web 100 gets printed by a printer with variable information and guillotine cutter of the printer cuts the label web 100 to proper label length to be applied to product.

Labelling happens manually or automatically. Challenge in linerless label printers is adhesive and dust accumulations to e.g. guillotine blade resulting shorter printer service cycle. In poorest case adhesive although perfect in application cannot be used as printer service cycle gets too short.

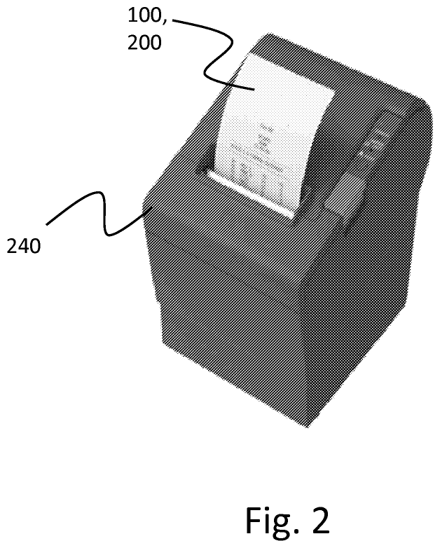

FIG. 2 shows an example of a label printer 240 useable together with a linerless label web 100 according to this disclosure. The label printer 240 may be called as a linerless label printer or linerless printer. These terms refer to a printer that is arranged to print linerless labels. The label printer 240 may be referred to as an on-demand label printer to emphasize that the printer may be used for printing the labels individually per need.

Business environments wherein such on-demand label printers are used typically call for very compact size and ease of use of those printer devices with minimal need for servicing. Thanks to the direct thermal printable linerless labels, the linerless labels themselves carry the thermally sensitive printable coating. This deviates from other non-direct thermal printing methods utilizing, for example, separate thermal print ribbons that need to be loaded into the printers and replaced after use accordingly.

Further, the number of individual components is selected to have minimal complexity. Preferably, the printer is also made very simple to use and has, for example, minimal need for any settings and adjustments.

Main functional parts inside such a compact linerless label printer may comprise: a mechanism for conveying a label web 100 through the printer, a thermal print head for printing the individual labels onto the label web 100 and a mechanism for separating individual labels from the label web 100 and providing them for manual dispensing.

The mechanism for conveying the label web 100 starting from unwinding the web from the label roll through all various parts of the printer and finally outputting the individual labels is typically a series of guidance rolls and guidance surfaces. To minimize both the size and complexity of such a unit, most of the rolls are freely running and perhaps only one or only a few of them are motorized in order to traction the label web 100 forward during printing. These rolls or surfaces may not utilize any special friction lowering coatings for cost effective structure. The traction roll(s) may also comprise simple plastic or rubber roll without any special coating but solely with a surface roughened in order to ensure traction. Typically, a single printer model is also designed to accept different widths of label rolls using a simple adapter to center the roll with respect to the web trajectory. Such a simple yet effective and economical printer design places severe demands on the linerless label web 100 in order to ensure smooth operation in customer service-oriented work. Typical challenges are related to pressure sensitive label web 100 sticking inside the printer to its various components and preventing smooth forward traction of the label web 100, and/or accumulation of adhesive residue onto printer components in prolonged use leading to the aforementioned problems and requiring cleaning of the printer components.

The thermal print head in this type of compact printers is typically selected to use lower print energies, i.e. less thermal energy may be transferred into the thermo-sensitive layers of the linerless label web 100. This is preferable in applications wherein short-lived labels are to be printed in a simple and economical manner. Even if the print heads could be adjusted for higher energy levels or temperatures, it may be preferable to run them on lower settings in order to maximize the use life of the thermal head/printer. It may also be that if the linerless label requires higher activation, the printing speed needs to be lowered due to the performance limitations of the printer.

In order to print, the thermo-sensitive linerless label web 100 may be tractioned via a gap between the thermal head and a platen roller. The printer sends an electric current to the heating elements of the thermal head, which generate heat. The heat activates the thermo-sensitive coloring layer of the thermosensitive paper, which changes color to black where heated. Such a printing mechanism is known as a thermal printing system or direct thermal printing system. The heating elements are usually arranged as a line of small closely spaced dots. The printing energy (temperature and/or exposure time) may be adjustable, but such adjustments tend to be tedious and preferably a direct thermal printable label material should be selected in order to work without a need to fine tune the printer properties. If more printing energy is required, this typically means that the printing speed is slowed down allowing the printing temperature to affect the label for longer time and therefore transferring more energy to the web. Therefore, the performance of the print head has an effect on selection of the thermal face material of the linerless label product in order to ensure good quality printing even with lower print energy/heat levels and higher printing speed.

The mechanism arranged in the output side of the printer for separating individual printed labels from the continuous linerless label web 100 may comprise various types of electrically motorized cutting blades or guillotines or in many cases just simple non-movable serrated cutting blades. The latter requires the user to manually tear the label web 100 against the serrated or toothed blade. In any case, the user needs to manually grasp the printed label that has been offered out from the printer. When using a non-motorized or non-assisted cutting mechanism, the user needs to grip the label rather firmly to manually separate it from the continuous web. This again places requirements for the label material so that it will not unnecessarily stick to the cutting mechanism of the printer or the fingers of the user who needs to be able to conveniently position the label into its first labelling position.

In view of being used in such printers, water-based acrylic adhesive provides less aggressive first tack meaning that after being opened from the label roll, the immediate tack of the PSA when guided through the printer is less aggressive compared, for example to hot melt-based PSAs. This helps, together with other features of the label, to minimize the adhesive residue build up inside the printer. The final tack builds up only after the label has been dispensed and left on the labelled item for a longer time. The label might even be removable over a certain period of time (minutes), before building a more permanent type of tack. Specific properties of PSA naturally depending on the exact formulation of the adhesive and surface materials to be labelled.

A linerless label product disclosed herein may be intended for end uses having a short label-life and requiring manual handling, repositionability and/or removability together with lean sustainable and economical structure.

The linerless label according to the specification can be particularly suitable for using with on-demand linerless label printer. Thus, it may reduce the problems caused by the through cutting of said printers. i.e., linerless label to be cut by a blade of a linerless label printer. The novel solution may prevent an accumulation of the adhesive coating 120 to a blade of the linerless label printer, which may result shortened printer service cycle. Thanks to the novel solution, adhesive accumulation to the blade of the printer may be significantly reduced. Further, adhesive accumulation to platen rolls and other parts of the linerless label printer may be significantly reduced.

Thus, there are multitude of requirements placed on the linerless label product in order to provide cost-efficient, efficient, and trouble-free operation in a user friendly and sustainable manner.

### Manufacturing Methods

A method for manufacturing a direct thermal linerless label web 100 comprising a face 110 may comprise the following steps:
supplying the face 110 having a direct thermal printable coating,
applying a water-based acrylic adhesive coating 121, and
thermally drying the adhesive coating 121 into a pressure sensitive adhesive coating 120.

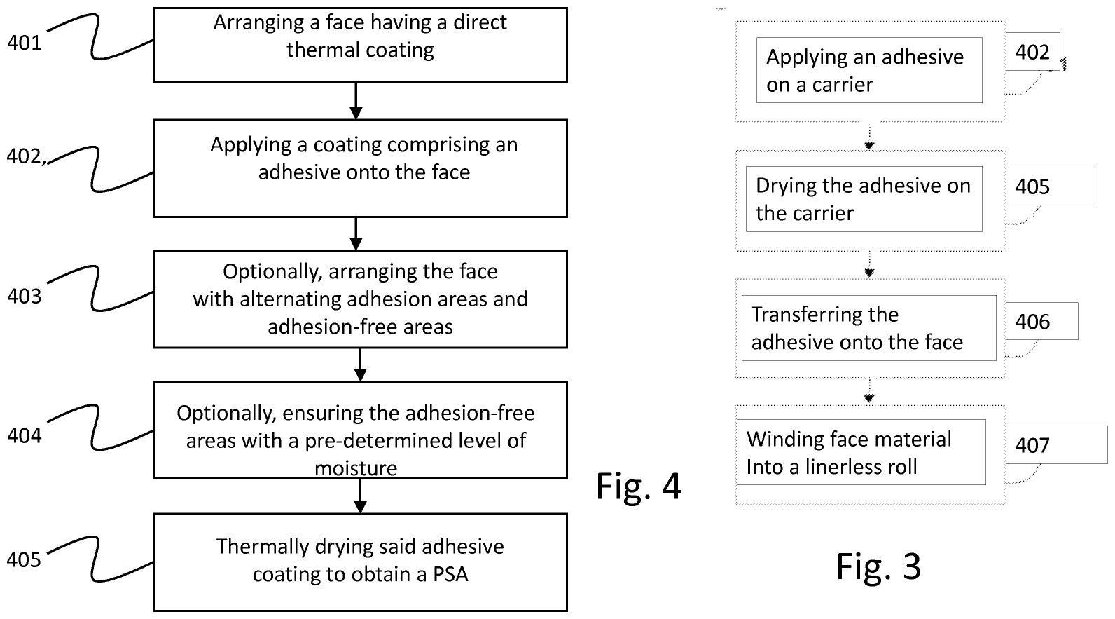

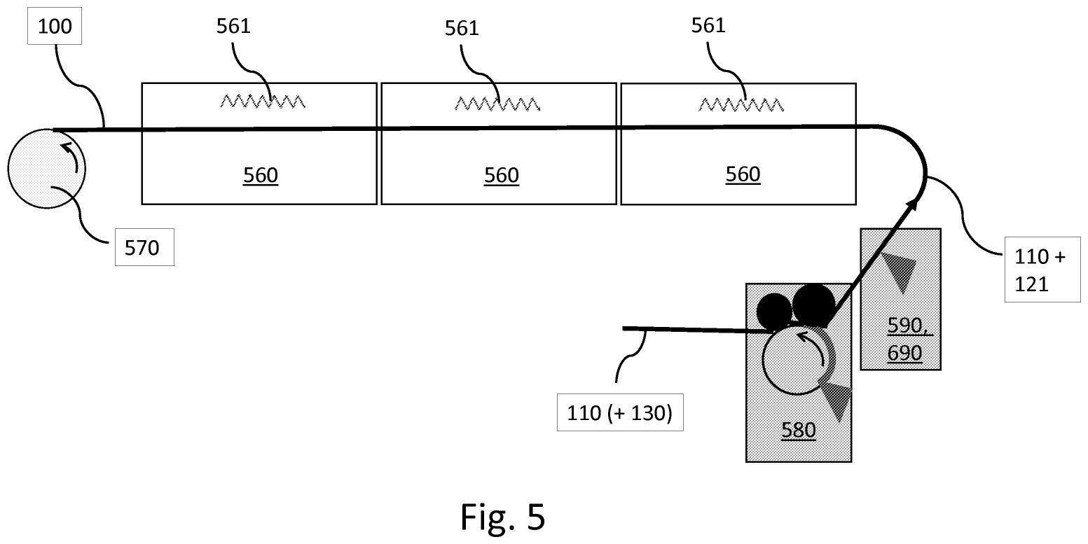

FIGS. 3-4 illustrates some example methods. The adhesive coating can be applied directly on to the face 110. In an embodiment, thanks to the reduced amount of wetting agents, the adhesive layer may be dried efficiently on the face. Therefore, a separate carrier material may not be needed. However, in an embodiment, the adhesive coating may be applied onto a carrier material 611, and the pressure sensitive adhesive coating 120 can be transferred from the carrier material onto the face 110.

Machine speed of the process may be, for example, 100-600 m/min.

According to an advantageous embodiment illustrated in FIG. 4, a method for manufacturing a linerless label web 100 comprising a direct thermal printable coating and a pressure sensitive adhesive is provided. The method may comprise
arranging a face comprising direct thermal printable coating (step 401),
applying adhesive coating 121 onto the face (step 402),
optionally, providing the face with alternating adhesion areas and adhesion-free areas (step 403),
optionally, ensuring the adhesion-free areas 150 with a pre-determined level of moisture (step 404), and
thermally drying the adhesive coating 121 into the pressure sensitive adhesive 120 (step 405).

Steps 402-404 of the method may be performed simultaneously or stepwise. Step 404 may also refer to maintaining or arranging the adhesion-free areas 150 with moisture.

### An Example of an Adhesive Coating Step

A coating unit 580 can be arranged for applying adhesive coating 121 onto a face 110.

The adhesive coating 121 may be applied onto the face 110 using a contact coating method, such as a roll coating, or curtain coating, foam coating or spray coating. The adhesive coating 121 may be applied by a direct gravure coating.

Alternatively, the coating unit 580 can be arranged to apply the adhesive 121 onto a carrier material. The coating step may comprise a contact coating method, such as a roll coating, or curtain coating, foam coating or spray coating.

As discussed, the adhesive coating 120, 121 may or may not be patterned.

Patterned adhesive refers to a situation wherein the adhesive covers less than 100% of the second side 112 of the face surface. For example, the adhesive may cover between 10% and 90% of the total area of the face 110. The adhesive may be arranged for example as stripes along longitudinal direction (i.e. the first direction) of the label web 100. Alternatively, the adhesive may be arranged, for example, as spots or other similar non-continuous areas. Thanks to these solution, contamination of the printer parts by the adhesive may be diminished. Further, from the economic and environmental point of view it is favorable to provide the label web 100, 200 with the adhesive solely on parts of the label necessary for providing the desired adhesion.

Thus, the adhesive layer may be a continuous layer. Alternatively, the adhesive layer may be a non-continuous layer having
1) adhesive areas, such as adhesive spots and/or adhesive stripes, and/or other kinds of adhesive areas, and
2) adhesion-free areas.

In an embodiment, the patterned adhesive is provided by first applying the adhesive coating 121 onto 100% area of the face 110 by the coating unit 580. After that some of the adhesive coating 121 is removed from the face 110 so as to provide the face 110 with alternating adhesion areas and adhesion-free areas 150 in the transversal direction of the face 110. Removing of the adhesive is performed before drying the adhesive in at least one drying unit 560. Removing of the adhesive may be performed by a unit 590. Therefore, areas wherefrom the adhesive is removed later on, will get moistened by the water contained by the adhesive. In this embodiment, the adhesive may be removed from the face by a blade, such as a nylon blade. The blade has the effect that while removing the adhesive, the blade simultaneously provides pressure to the face 110, thus pushing moisture, i.e. water contained by the adhesive into the face 110.

FIG. 6 provides a detailed view of the method and the apparatus according to an embodiment. The adhesive coating 121 is applied onto 100% area of the face 110 by the coating unit 580. After that, some of the adhesive coating 121 is removed from the face 110 so as to provide the face 110 with alternating adhesion areas and adhesion-free areas 150 in the transversal direction of the face 110. A unit 690 is arranged to remove the adhesive coating 121 in order to provide the face 110 with adhesive stripes visualized as black blocks 121 in dashed enlargement of FIG. 6. Grey droplets of FIG. 6 illustrate the adhesive coating removed from the face 110. Adhesive removed from the face 110 may be collected and returned back to the coating unit, as illustrated by the curved arrow between the unit 690 and the coating unit 580.

Alternatively, the patterned adhesive, if used, may be provided applying the adhesive coating 121 only locally onto the face 110 so as to provide the face 110 with alternating adhesion areas 121 and adhesion-free areas 150 in the transversal direction of the face 110. This is illustrated in FIG. 7. The adhesion areas, i.e. the adhesive 121 stripes, are visualized as black blocks in FIG. 7. In order to prevent activation of the thermal paper while drying the adhesive, moisture may be provided onto the adhesion-free areas 150 of the face 110 prior to drying of the adhesive coating 121 into the pressure sensitive adhesive 120. Moisture may be provided by a unit 590, the unit 590 in this case being e.g. a water sprayer. The water sprayer can be arranged to provide a water spray solely on the adhesion-free areas 150 as illustrated by the grey arrows in FIG. 7.

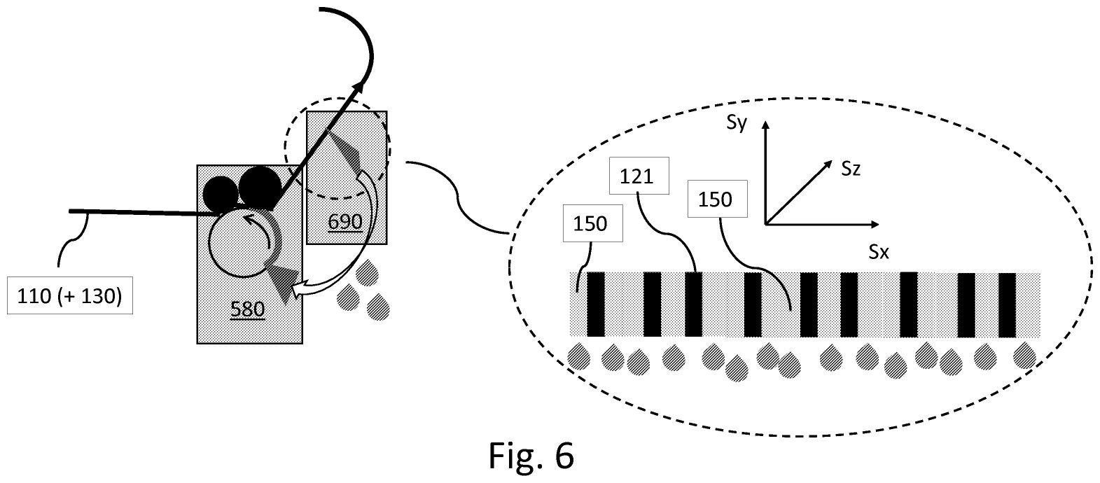

Therefore, downstream of the coating unit 580 the apparatus may comprise
a unit 590 for adhesive removal as shown in FIG. 6, and/or
a moisturizing unit 690 as shown in FIG. 5.

Ensuring the adhesion-free areas 150 (shown e.g. in FIG. 7) with a pre-determined level of moisture has the effect that when drying the adhesive the moisture will evaporate, which evaporation prevents temperature of the thermal paper from increasing to values that would cause activation of the thermal paper.

### An Example of a Drying Step

The adhesive coating 121 may be dried in at least one drying unit 560.

During a drying process, solids content of the adhesive coating increases. For direct thermal linerless labels, the correct drying process may be the most important stage for obtaining a product having excellent properties.

Adhesive haze is a test to identify how well adhesive layer has been dried during the drying step. Well dried direct thermal linerless labels may improve printing properties as well as reduce bleeding tendency of the product.

Wetting agents can be added to optimize surface tension of adhesives. Wetting agents may be particularly used to increase spreading and penetrating properties by lowering a surface tension of the adhesive. Wetting agents may also improve mechanical stability of the coating layer. Thus, wetting agents may be added to improve mechanical stability to run on high shear coaters without generating grit. Furthermore, wetting agents may be used for obtaining good leveling and flow to gain uniform film formation.

However, surprisingly, by minimizing amount of wetting agent(s), even down to 0 wt. %, it was possible to significantly improve certain properties of the direct thermal linerless label without affecting to the runnability. For example, without the wetting agents, surfactants (and particularly non-free surfactants) may be substantially uniformly dispersed in the formed adhesive, therefore, improving easiness of drying process and improving quality of the formed linerless label web. Thanks to the minimized about of free surfactant(s) in the water-based acrylic adhesive, for example, printing quality can be significantly improved.

Direct thermal printable coating of the face has traditionally prevented utilizing water-based adhesives with linerless labels. Thermal coating is activated using heat. This may prevent drying and/or heating water-based adhesive on a thermal paper, since heating may lead to activation and the thermal paper becoming blackish or causing less severe but unwanted visual changes. The partly or fully activated brownish or blackish thermal paper surface prevents providing a high-quality visible print on it. Drying with lower temperatures and lower coat weight (i.e. with less mass to be dried) may be possible, but without very careful selection of drying process parameters would in turn cause at least ineffectiveness and longer drying times and/or dimensions (length) of the drying chamber or oven.

It should be noted that a certain coating thickness (coat weight) is needed in order to obtain the water-based PSA as a uniform, defect free layer on the face 110. Simply lowering the adhesive coating thickness under a certain value in an effort to facilitate drying at lower temperatures and without increasing the drying time can lead to unsatisfied PSA quality and performance. A low coat weight may have a negative effect on PSA adhesion on labelled surface. Especially, if good adhesion and at the same time removability and/or repositionability is required, these call for higher coat weight of the PSA and this is especially emphasized in case of water-based adhesives. Thanks to the solution according to this specification, the adhesive coating may become fully dried easier than conventionally. Therefore, it may be possible to achieve good PSA quality and performance but yet to prevent overheating of the thermally sensitive coating.

In an embodiment, the reduced wetting agent content may help to dry the adhesive coating layer in a controlled manner. By using a dosage of wetting agents less than 0.3 wt. %, preferably equal to or less than 0.2 wt. %, even down to 0 wt. %, water may not trap so easily into the coating and easiness of the drying process can be improved. The reduced amount of free surfactant(s), such as the wetting agent, may improve the drying process, because the non-free surfactants can be more uniformly dispersed in the formed adhesive layer and, hence, the formation of segregated hydrophilic islands may be avoided.

The apparatus can comprise at least one drying unit 560 for drying the adhesive coating 121. The drying unit can comprise at least one drying device 561. As a result of the drying, the pressure sensitive adhesive 120 is obtained.

The adhesive 121 is dried in order to evaporate water from the water-based adhesive. Drying comprises heating. Heating may be implemented by at least one of the following: infrared heating, microwave heating or air blow. Preferably the adhesive 121 is dried by air blow or by air blow together with another type of drying. Another type of drying may comprise infrared energy and/or microwave energy. This ensures suitable level of pre-heating of the adhesive to start the evaporation of the moisture from within the adhesive layer but preventing the skinning of the adhesive layer top surface that would block the moisture from escaping out deeper from the adhesive layer.

The drying phase of the machine comprising the drying unit(s) may have a total length of between 20 and 40 meters.

If the adhesive coating 121 is dried on the face 110, the drying unit 560 may have a temperature of between 60 and 90 degrees C. or in some cases even higher up to and above 100 degrees C. Preferably the drying temperature is at least 75 degrees C. in order to ensure that the water-based adhesive becomes fully dried and provides maximum adhesive performance such as adhesion. The face 110 comprising the adhesive coating 121 thereon may be arranged to proceed through the drying unit 560. Thus, a linerless label web 100 is formed.

Temperature of the linerless label web 100 when exiting thermal drying may be arranged to be from 5 to 15 degrees C. below an activation temperature of the direct thermal printable coating. From economical point of view, it may be preferable to arrange the temperature of the linerless label web 100 when exiting thermal drying to be as close to the activation temperature of the direct thermal printable coating as possible. Furthermore, e.g. low wetting agent content may reduce drying costs of the product.

After drying of the adhesive, the face 110 with the pressure sensitive adhesive thereon, i.e. the linerless label web 100 can be wound onto a roll 570 of linerless label web 100.

According to an embodiment, the adhesive for the linerless label web is dried separately on a carrier material 611, before attaching the adhesive onto a face of the label. This avoids problems arising from heat sensitivity and enables usage of environmentally friendly water-based adhesives in such linerless labels. For such use, even lower grade and more economical materials can be used as the adhesive is separately dried using a separate carrier material 611, such as a metal belt or a web.

The carrier material 611, if used, may be a belt, for example a silicone belt, a plastic belt, such as a nylon belt, or a metal belt, such as a steel belt. Alternatively, the carrier material 611 may be a batch of a web material. In this embodiment, the adhesive coating 121 is in the first step 402 applied on a carrier material 611. Then, in the second step 405, the adhesive coating 121 is dried/cured into PSA 120 on the carrier material 611 by conveying the carrier through a drier. The dried water-based adhesive 120 is transferred onto a face 110 of a label web 100 in the third step 406. Finally, the face with the pressure sensitive adhesive is wound into a roll of a linerless label web 100 in the fourth step 407. In this embodiment, the drying/curing of the adhesive coating 121 takes place on a separate carrier material 611 and therefore the thermally sensitive coating(s) of the face is/are not exposed to temperatures exceeding the activation temperature of said thermally sensitive coating.

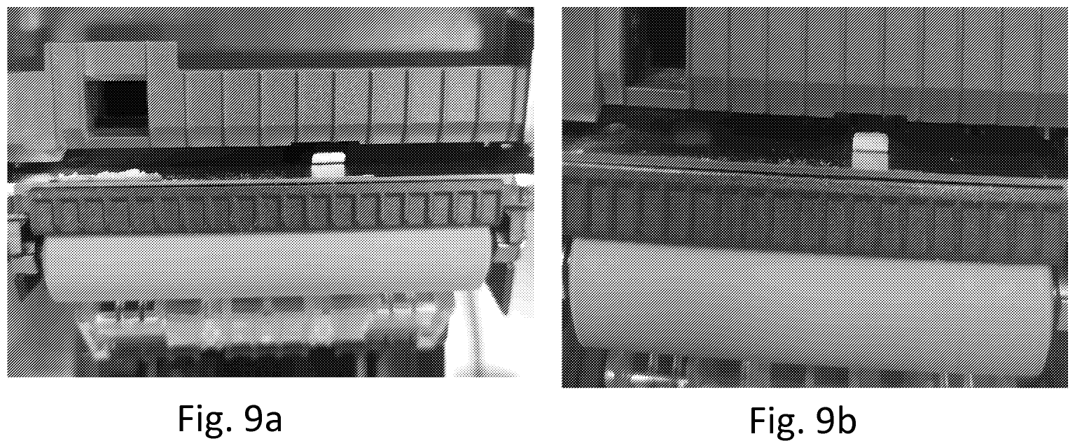

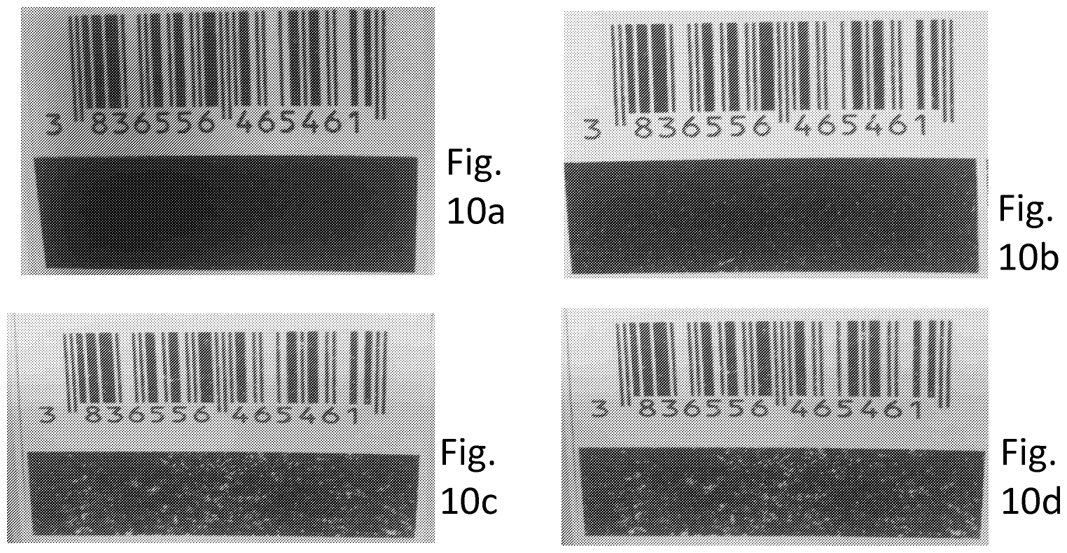

An example approach for the manufacturing method using a carrier material is illustrated in FIG. 8. According to the embodiment schematically described in FIG. 8, the carrier material is arranged to be an endless belt. Alternatively to the endless belt, the carrier material may be arranged to be a reusable batch of a web material (not shown in Figures). The apparatus comprising the carrier material may comprise an unwinder 612 for the face 110. After dried, the adhesive 120 may be attached to the face 110. The unwound face 110 and the dried water-based adhesive on the belt 611 can be attached in a nip 660, thereby forming a linerless label web 100. The formed linerless label web 100 can be wound up to a roll 570. The apparatus may further comprise a cooling cylinder 650. The cooling cylinder may be situated before the point wherein the dried water-based adhesive layer is attached to the face 110.

The formed linerless label web 100 is arranged to be rolled onto a linerless label web roll 570. The label web roll 570 may be stored and/or transported for later processing. Label web roll 570 may be further processed in other location.

Thanks to the present invention, many advantages may be obtained. For example, at least some of the following advantages may be obtained:
1) Water-based acrylic PSA having a wetting agent content of less than 0.3 wt. %, preferably equal to or less than 0.2 wt. %, may reduce bleeding related problems in on-demand printers.
2) Reliable adhesion/tackiness of the adhesive may be obtained for all of those different types of surfaces onto which the label will be manually dispensed or applied, e.g. during the preparation of the order (for example in the kitchen) or when labelling the various items of the order (for example cups, boxes, wraps, bags, or other packages).
3) Easy repositionability may be obtained so that the label is first applied onto a first surface and then repositioned onto another surface. For example, label may be used first in the kitchen as a note and then labelled onto the ready-made dish.
4) Easy removability may be obtained, for example for customers removing the label used as a closure or seal for a package.
5) Permanent final tack of the label may be achieved in applications where lower first tack is beneficial to reduce adhesive build up in the printer but permanent type of tack of label is preferred after dispensing on the item to be labelled.
6) Suitable chemistry either for direct or indirect food contact may be obtained.
7) Sustainability supporting the short life of such labels may be obtained, i.e. chemistry which does not create undue burden to the environment or call for any special waste management procedures compared to other waste that becomes generated in the processes and activities where such labels are used.

This invention particularly relates to a linerless label to be cut by a blade of a linerless label printer. With conventional linerless labels, dust and adhesive can start soon to accumulate to a blade of the linerless label printer, resulting shorted printer service cycle. Sometimes, a linerless label having otherwise perfect adhesive may not be used at all because a printer service cycle would get too short. Thanks to the novel invention, dust and adhesive accumulation to the blade, platen roll and other parts of the linerless label printer may be significantly reduced. Furthermore, printing quality of aged direct thermal linerless labels may be significantly improved.

### Experimental Tests

### Example 1

Water-based acrylic adhesive coatings were prepared. Surfactants were used so that a total amount of wetting agents in the adhesive coatings varied between 0% and 1.3%, calculated from total dry weight of the adhesive coating layer.

According to the test results, wetting agents had a significant effect on drying, and on printing quality. The best results were found when the amount of the wetting agent did not exceed 0.3 wt. %.

Surprisingly, the wetting agent, if used a dosage of more than 0.2 wt. %, such as more than 0.3 wt. %, and particularly if used more than 0.5 wt. %, such as more than 0.6 wt. % (by dry weight from the adhesive coating), caused decreased printing quality. Thus, more wetting agents meant worse printing quality. Moreover, wetting agents decreased drying efficiency of the adhesive coating.

According to the test results, direct thermal linerless labels comprising less than 0.6 wt. % wetting agents, and particularly equal to or less than 0.3 wt. % wetting agents, had significantly better properties than otherwise similar products having more than 0.6 wt. % wetting agents.

Some test points are shown in FIGS. 10a to 10d.

FIG. 10a shows a test point having a wetting agent dosage of 0.2 wt. %, printed after 12 weeks of aging. FIG. 10b shows a test point having a wetting agent dosage of 0.5 wt. %, printed after 12 weeks of aging. FIG. 10c shows a test point having a wetting agent dosage of 1.3 wt. %, printed after 7 weeks of aging. FIG. 10d shows a test point having a wetting agent dosage of 1.3 wt. %, printed after 9 weeks aging.

As can also be seen from the photos, the test point having a wetting agent dosage of 0.2 wt. % (FIG. 10a) had clearly better printing result than the test point having a wetting agent dosage of 0.5 wt. % (FIG. 10b). These samples were printed after aging the direct thermal linerless labels 12 weeks.

Furthermore, by using a wetting agent dosage of 1.3 wt. %, printing quality was quite poor only after 7 weeks aging (FIGS. 10c-d).

Surprisingly, in case of a dosage of less than 0.3 wt. %, such as equal to or less than 0.2 wt. %, only very small changes may occur in 12th week after forming the linerless label web.

In case of a wetting agent dosage of 0.5 wt. %, quality was significantly decreased after 9^{th} week.

Furthermore, by using a dosage of more than 1 wt. %, such as 1.3 wt. %, the printing quality was quickly poor.

The worst result can be seen after 12 weeks. After 12 weeks, all test points having a dosage of more than 0.3 wt. % wetting agents (FIGS. 10b to d) had a decreased printing quality. Test points having a wetting agent dosage of less than 0.3 wt. %, such as 0.2 wt. % (FIG. 10a), had a good printing quality even after said 12 weeks.

Furthermore, the wetting agent has also a significant effect on bleeding. By using less than 0.5 wt. %, such as equal to less than 0.3 wt. % wetting agents, and most preferably by using adhesive without the wetting agent, bleeding was avoided or at least diminished. FIG. 11a shows a test point with a wetting agent, wherein dosage of the wetting agent was more than 0.5 wt. %, and FIG. 11b shows a test point without wetting agents.

Differences in printing quality were clearly seen. Test results further confirmed that the novel linerless label webs without wetting agent, or with reduced amount of wetting agent, had good functionality. Further, significant difference in bleeding tendency was found between the standard materials having the wetting agent and the novel product with reduced amount of wetting agents.

### Example 2

Adhesive coatings with reduced amount of wetting agent and with silicone additive were formed by mixing silicone emulsion to acrylic water-based adhesive. The adhesive coatings comprised emulsified silicone additive and water-based acrylic adhesive. The total amount of the silicone additive in the adhesive coatings varied between 0% and 6%, calculated from the total dry weight of the adhesive coating layer.

According to the test results, 1 wt. % emulsified silicone additive in the adhesive modified the adhesive performance. The best results were found when the amount of the emulsified silicone additive exceeded 2 wt. %. For cost reasons, the content of silicone was kept between 1 wt. % and 6 wt. %, i.e., the maximum amount of silicone was 6 wt. %.

The linerless label comprising the emulsified silicone additive had some significantly better properties than same products without the emulsified silicone additive.

The amount of the cuts depended on the amount of silicone additive so that the best results were achieved when the amount of the silicone additive was between 2 wt. % and 6 wt. %, calculated from the total dry weight of the adhesive coating.

Thus, the adhesive coatings with reduced amount of wetting agent and with added silicone additive were suitable to be used for the acrylic water-based adhesive. Further, the label comprising the adhesive coating comprising the silicone additive was each time firmly attached to the surface of the labeled product.

The invention is not limited solely to the examples presented in Figures and the above description, but it may be modified within the scope of the appended claims.

1. A method for manufacturing a direct thermal linerless label web, the direct thermal linerless label web comprising
a face having a first side and a second side, and
a water-based acrylic pressure sensitive adhesive coating on the second side of the face,
the face comprising
a base layer, and
a direct thermal printable coating,
wherein the method comprises
supplying the face,
applying a water-based acrylic adhesive coating comprising free and/or non-free surfactant(s),
wherein
a total amount of the surfactant(s), excluding surface active polymerization agent(s), is from 0 wt. % to less than 0.6 wt. %, calculated from the total dry weight of the water-based acrylic adhesive coating,
and
thermally drying the water-based acrylic adhesive coating into the water-based acrylic pressure sensitive adhesive coating,
wherein the water-based acrylic adhesive coating is applied directly onto the face, or the water-based acrylic adhesive coating is first applied onto a carrier material, and then transferred onto the face, thereby obtaining the direct thermal linerless label web comprising the water-based acrylic pressure sensitive adhesive coating on the second side of the face.

2. A direct thermal linerless label web obtainable by a method according to claim 1.

3. A direct thermal linerless label web comprising
A) a face having a first side and a second side, the face comprising
a base layer, and
a direct thermal printable coating, and
B) a water-based acrylic pressure sensitive adhesive coating on the second side of the face, the water-based acrylic pressure sensitive adhesive coating being obtained from a water-based acrylic adhesive coating comprising free and/or non-free surfactant(s),
wherein a total amount of the surfactant(s), excluding surface active polymerization agent(s), is from 0 wt. % to less than 0.6 wt. %, calculated from the total dry weight of the water-based acrylic adhesive coating.

4. The direct thermal linerless label web according to claim 3, wherein amount of the free surfactant(s), excluding surface active polymerization agent(s), is equal to or less than 0.3 wt. %, calculated from the total dry weight of the water-based acrylic adhesive coating.

5. (canceled)

6. The direct thermal linerless label web according to claim 3, wherein, from said surfactants, amount of wetting agent(s) is equal to or less than 0.3 wt. %, calculated from the total dry weight of the water-based acrylic adhesive coating.

7. (canceled)

8. The direct thermal linerless label web according to claim 3, wherein the surfactant(s) comprise(s) the non-free surfactant(s).

9. The direct thermal linerless label web according claim 6, wherein amount of the non-free surfactant(s), including the surface active polymerization agent(s), is at least 0.8 wt. % (by dry weight) from the water-based acrylic adhesive coating.

10. The direct thermal linerless label web according to claim 6, wherein amount of said non-free surfactant(s) is at least 10% greater than amount of said free surfactant(s), calculated from the total dry weight of the water-based acrylic adhesive coating, including the surface active polymerization agent(s).

11. The direct thermal linerless label web according to claim 3, wherein total amount of the free surfactant(s), including the surface active polymerization agent(s), is equal to or less than 2 wt. % (by dry weight) determined from the water-based acrylic adhesive coating.

12. (canceled)

13. The direct thermal linerless label web according to claim 3, wherein the water-based acrylic adhesive coating is an aqueous polymer emulsion derived from components comprising acrylate monomer(s), vinyl aromatic compound(s) and at least one surface active polymerization agent.

14. The direct thermal linerless label web according to claim 3, wherein the surface active polymerization agent(s) comprise(s) at least one reactive surface active polymerization agent.

15. The direct thermal linerless label web according to claim 3, wherein the water-based acrylic adhesive coating is a non-tackified water-based acrylic adhesive coating.

16. The direct thermal linerless label web according to claim 3, wherein the water-based acrylic adhesive coating comprises a tackifier, wherein amount of the tackifier is more than 0 wt. % and less than 35 wt. % calculated from the total dry weight of the water-based acrylic adhesive coating.

17. The direct thermal linerless label web according to claim 3, wherein a total coverage of the adhesive coating is in a range between 10% and 90%, calculated from total area of the second side of the face.

18. The direct thermal linerless label web according to claim 3, wherein the water-based acrylic pressure sensitive adhesive coating has a coat weight in a range between 10 g/m² and 25 g/m² (by dry weight).

19. The direct thermal linerless label web according to claim 3, wherein the pressure sensitive adhesive coating comprises an emulsified silicone additive, the amount of the emulsified silicone additive being in a range between 1 wt. % and 6 wt. %, calculated from the total dry weight of the adhesive coating.

20. The direct thermal linerless label web according to claim 3, wherein a total mineral content of the direct thermal linerless label web is in a range between 0 and 20 wt. %, calculated from total dry weight of the direct thermal linerless label web.

21. The direct thermal linerless label web according to claim 3, wherein the direct thermal printable coating has a grammage in a range between 1 g/m² and 5 g/m² and/or the face further comprises a top coating on the direct thermal printable coating, wherein the top coating preferably has a grammage in a range between 0.5 g/m² and 3 g/m².

22. (canceled)

23. The direct thermal linerless label web according to claim 3, wherein the face further comprises an intermediate layer disposed between the base layer and the direct thermal printable coating, the intermediate layer having a grammage in a range between 0.9 g/m² and 7 g/m².

24. The direct thermal linerless label web according to claim 3, wherein the direct thermal linerless label web further comprises a release layer on top of the face, wherein the release layer on top of the face comprises a non-thermally curable release coatings.

25. (canceled)

26. (canceled)
